(19) United States
(12) Patent Application Publication
(10) Pub. No.: US 2009/0319238 A1
(43) Pub. Date: Dec. 24, 2009

(54) SIMULATION SCORING SYSTEMS

(76) Inventor: Raynald Bedard, Prescott, AZ (US)

Correspondence Address: Stoneman Volk Patent Group, 3770 NORTH 7TH STREET, Suite 100, PHOENIX, AZ, 85014, US

(21) Appl. No.: 12/124,858

(22) Filed: May 21, 2008

Related U.S. Application Data
(60) Provisional application No. 60/983,499, filed on Oct. 29, 2007.
(60) Provisional application No. 60/939,253, filed on May 21, 2007.

(51) Int. Cl. G06G 7/48

(52) U.S. Cl. 703/6

(57) ABSTRACT

Simulation scoring systems including software, methods of use, and related methods that provide for simulating and scoring of aircraft flight and other missions, particularly where such simulating is purely electronic and particularly where such scoring is objective and particularly where such scoring has a plurality of gradations, as to distinguish a plurality of skill levels.

### CROSS-REFERENCE TO RELATED APPLICATIONS

The present application is related to and claims priority from prior Provisional Application Ser. No. 60/939,253, filed May 21, 2007, entitled “SIMULATION SCORING SYSTEMS”, and is related to and claims priority from Prior Provisional Application Ser. No. 60/983,499, filed Oct. 29, 2007, entitled “SIMULATION SCORING SYSTEMS”, the contents both of which are incorporated herein by this reference and are not admitted to be prior art with respect to the present invention by the mention in this cross-reference section.

### BACKGROUND

This invention relates to simulation scoring systems. More particularly, this invention relates to providing methods and associated computing systems and technology systems to simulate and score aircraft flight-missions, particularly where such simulating is purely electronic.

Presently, scoring of aircraft flight-missions is not objective. Further, scoring of aircraft flight-missions does not include use, for example, of a plurality of gradations that, for example, act to distinguish among a plurality of pilot skill levels. Even further, systems that permit instructors to evaluate trainees in an objective manner are needed.

Thus a great need exists for a system for simulating and scoring of aircraft flight-missions, which system is capable of effectively providing useful scoring of simulated aircraft flight-missions, especially as the same may relate to better commercialization of such systems in gaming and educational fields.

### OBJECTS AND FEATURES OF THE INVENTION

A primary object and feature of the present invention is to overcome the above-stated problems and provide efficient and workable solutions. Another primary object and feature is to provide methods, computing systems, and associated technology systems for electronically simulating and scoring of simulations.

It is a further object and feature of the present invention to provide methods and technology systems for electronically simulating and scoring of aircraft flight-missions, where the scoring of the aircraft flight-missions—rather than relying primarily upon human judgment—comprises computer scoring.

It is a still further object and feature of the present invention to provide methods and technology systems for electronically simulating and scoring of aircraft flight-missions, where the scoring of the aircraft flight-missions has a plurality of gradations relating to varying skill-levels of maneuvering of a simulated aircraft.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a simulation scoring computing system comprising: at least one scorable mission computing system to run at least one scorable mission with at least one simulation engine; at least one score calculator computing system to calculate the score of such at least one scorable mission when performed by at least one mission performer; at least one calculated score requester computing system to request at least one calculated score of such at least one scorable mission performed by at least one mission performer; at least one calculated score reporter computing system to report at least one calculated score of such at least one scorable mission performed by at least one mission performer; at least one calculated score storer computing system to store the requested at least one calculated score of such at least one scorable mission performed by at least one mission performer; and at least one management application computing system useable to manage at least such at least one scorable mission and such at least one calculated score.

Moreover, it provides such a simulation scoring computing system, wherein such at least one management application computing system comprises at least one scorable mission assignment assister computing system to assist assignment of such at least one scorable mission to at least one mission performer. Additionally, it provides such a simulation scoring computing system, wherein such at least one management application computing system comprises at least one scoring criteria manager computing system to manage the scoring criteria of such at least one scorable mission. Also, it provides such a simulation scoring computing system, wherein such at least one management application computing system comprises at least one calculated score viewer computing system to view such at least one calculated score of such at least one scorable mission. In addition, it provides such a simulation scoring computing system, wherein such at least one management application computing system comprises at least one course associater computing system to associate such at least one scorable mission with at least one curricular course. And, it provides such a simulation scoring computing system, wherein such at least one management application computing system comprises at least one section associater computing system to associate such at least one curricular course with at least one section.

Further, it provides such a simulation scoring computing system, wherein such at least one management application computing system comprises at least one academic term associater computing system to associate such at least one curricular course with at least one academic term. Even further, it provides such a simulation scoring computing system, wherein such at least one management application computing system comprises at least one mission-performer access manager computing system to manage mission-performer access to such at least one scorable mission. Moreover, it provides such a simulation scoring computing system, further comprising at least one network accessible storage of such at least one scorable mission. Additionally, it provides such a simulation scoring computing system, further comprising at least one mission-performer calculated score associater computing system to associate such at least one calculated score with at least one mission performer. Also, it provides such a simulation scoring computing system, wherein such at least one management application computing system comprises at least one mission performer associater computing system to associate at least one mission performer with at least one curricular course. In addition, it provides such a simulation scoring computing system, wherein such at least one management application computing system comprises at least one curricular instructor associater computing system to associate at least one curricular instructor with at least one curricular course.

In accordance with another preferred embodiment hereof, this invention provides a method, relating to a simulation scoring system, comprising the steps of: selecting at least one simulation engine; developing at least one scorable mission integration system with the at least one simulation engine; developing at least one scorable mission; storing such at least one scorable mission in at least one scorable mission database; and providing access to the at least one scorable mission database. And, it provides such a method, further comprising the step of providing receiving at least one score related to at least one scorable mission that has been completed. Further, it provides such a method, further comprising the steps of providing at least one scorable mission manager application to assist managing data related to at least one scorable mission that has been completed. Even further, it provides such a method, wherein the at least one scorable mission manager application comprises: at least one scorable mission selection assister computing system to assist selection of at least one scorable mission; at least one scorable mission launcher computing system to launch at least one scorable mission; at least one simulation engine launcher computing system, responsive to such at least one scorable mission launcher, to launch at least one simulation engine; at least one score analyzer computing system to analyze at least one scorable occurrence during performance of such at least one launched scorable mission; and at least one score recorder computing system to record at least one analyzed score.

In accordance with another preferred embodiment hereof, this invention provides a scorable mission manager application computing system of a simulation scoring computing system comprising: at least one scorable mission selection assister computing system to assist selection of at least one scorable mission; at least one scorable mission launcher computing system to launch at least one scorable mission; at least one simulation engine launcher computing system, responsive to such at least one scorable mission launcher, to launch at least one simulation engine; at least one score analyzer computing system to analyze at least one scorable occurrence during performance of such at least one launched scorable mission; and at least one score recorder computing system to record at least one analyzed score. Moreover, it provides such a scorable mission manager application computing system further comprising at least one score displayer computing system to display such at least one analyzed score upon completion of such at least one launched scorable mission. Additionally, it provides such a scorable mission manager application, further comprising at least one score submission assister computing system to assist submission of at least one score to at least one score storage database.

In accordance with another preferred embodiment hereof, this invention provides a simulation scoring computing system comprising: at least one piloting simulator computing system to simulate aircraft piloting on at least one computer; at least one flyable mission computing system to simulate at least one flight mission flyable by at least one user using such at least one piloting simulator; and at least one scorable-event computing system contained within such at least one flyable mission computing system; wherein such at least one scorable event computing system comprises at least one score customization computing system. Also, it provides such a simulation scoring system, further comprising at least one score computing system to compute at least one summary score. In addition, it provides such a system, further comprising at least one score display computing system to display such at least one summary score.

In accordance with another preferred embodiment hereof, this invention provides a computational system comprising: at least one piloting simulation computer processor adapted to simulate aircraft piloting on at least one computational platform; at least one flyable mission computer processor adapted to simulate at least one flight mission flyable by at least one user using such flyable mission computer processor; at least one scorable-events computer processor adapted to generate multiple quantitative scoring levels of each of a plurality of scorable events along such at least one simulated flight mission to provide at least one scorable mission; and at least one scorer computer processor adapted to provide at least one summary score, relating to such at least one scorable mission, relating to such generated multiple quantitative scoring levels of each such one of such plurality of scorable events. And, it provides such a computational system, further comprising at least one score viewer to permit viewing such multiple quantitative scoring levels. Further, it provides such a computational system, further comprising at least one parsing system to parse at least one certification requirement of at least one real-life certifying organization and to provide use the parsed at least one certification requirement as at least one scorable event. Even further, it provides such a computational system, further comprising at least one simulator for simulating at least one certification requirement of at least one real-flight certification of at least one real-life certifying organization. Even further, it provides such a computational system, further comprising at least one score ranker to provide at least one ranking of scores. Even further, it provides such a computational system, further comprising at least one score ranker to provide at least one ranking of scores.

In accordance with another preferred embodiment hereof, this invention provides a method comprising the steps of: providing at least one simulation platform; providing at least one simulated mission operable by at least one user using such at least one simulation platform; providing quantitative scoring of a plurality of scorable events along such at least one simulated mission by generating multiple quantitative scoring levels of each of such plurality of scorable events along such at least one simulated mission to provide at least one scorable mission; and providing at least one network to operate such at least one simulated platform; and wherein such at least one user may connect with such at least one network to operate such at least one simulated mission. Even further, it provides such a method, wherein such at least one simulated mission is at least one simulated spaceflight mission. Even further, it provides such a method, wherein such at least one simulated mission is at least one simulated sea-going mission. Even further, it provides such a method, wherein such at least one simulated mission is at least one simulated complex-operating-machinery mission. Lastly, it provides for every novel method, step, apparatus and/or process disclosed or taught herein.

### BRIEF DESCRIPTION OF THE DRAWINGS

FIG. 1 shows an overall schematic illustration of a method relating to aircraft electronic flight-mission simulation and scoring systems, according to a preferred embodiment of the present invention.

FIG. 2 shows a schematic illustration of operational functions of a method for aircraft electronic flight-mission simulation and scoring, according to a preferred embodiment of the present invention.

FIG. 3 shows a schematic illustration of a web-based electronic commerce system, according to a preferred embodiment of the present invention.

FIG. 4 shows a schematic view illustrating preferred use-cases according to a preferred embodiment of the present invention.

FIG. 5A, FIG. 5B, and FIG. 5C together show a schematic view illustrating a preferred domain object model, according to a preferred embodiment of the present invention.

FIG. 6 shows a schematic view illustrating a preferred object state diagram, according to a preferred embodiment of the present invention.

FIG. 7 shows a schematic view illustrating a preferred database structural design, according to a preferred embodiment of the present invention.

FIG. 8 shows a schematic view illustrating a preferred object interaction diagram for calculating a score of a scorable mission, according to a preferred embodiment of the present invention.

FIG. 9 shows a schematic view illustrating a preferred object interaction diagram for entering and modifying a score of a scorable mission, according to a preferred embodiment of the present invention.

FIG. 10 shows a schematic view illustrating a preferred object interaction diagram for viewing a score, according to a preferred embodiment of the present invention.

FIG. 11 shows a schematic view illustrating a preferred object interaction diagram for entering and modifying an educational course, including at least one scorable mission, according to a preferred embodiment of the present invention.

FIG. 12 shows a schematic view illustrating a preferred object interaction diagram for entering and modifying at least one course grade of at least one scorable mission by at least one grading instructor, according to a preferred embodiment of the present invention.

FIG. 13 shows a schematic view illustrating a preferred object interaction diagram for entering and modifying at least one student course grade of at least one scorable mission by at least one grading instructor, according to a preferred embodiment of the present invention.

FIG. 14 shows a schematic view illustrating a preferred object interaction diagram for displaying at least one welcome window for at least one scorable mission, according to a preferred embodiment of the present invention.

FIG. 15 shows a schematic view illustrating a preferred object interaction diagram for flying at least one scorable mission, according to a preferred embodiment of the present invention.

FIG. 16 shows a schematic view illustrating a preferred object interaction diagram for setting at least one scorable mission for at least one student, according to a preferred embodiment of the present invention.

FIG. 17 shows a front view illustrating a preferred login screen for at least one user of at least one scorable mission, according to the preferred embodiment of the present invention.

FIG. 18 shows a front view illustrating a preferred viewing screen for viewing at least one score filtering criterion for at least one student, according to a preferred embodiment of the present invention.

FIG. 19 shows a front view illustrating a preferred managing screen for managing at least one student management criterion for at least one student by at least one grading instructor, according to a preferred embodiment of the present invention.

FIG. 20 shows a front view illustrating a preferred managing screen for managing at least one student course criterion for at least one student course by at least one course manager, according to a preferred embodiment of the present invention.

FIG. 21 shows a front view illustrating a preferred interactive screen for adding at least one course for at least one student by at least one course manager, according to a preferred embodiment of the present invention.

FIG. 22 shows a front view illustrating a preferred interactive screen for adding and modifying at least one student credential for at least one student by at least one course manager, according to a preferred embodiment of the present invention.

FIG. 23 shows a front view illustrating a preferred managing screen for managing at least one course for at least one student by at least one course manager, according to a preferred embodiment of the present invention.

FIG. 24 shows a front view illustrating a preferred selecting screen for selecting at least one course term for at least one student by at least one course manager, according to a preferred embodiment of the present invention.

FIG. 25 shows a front view illustrating a preferred managing screen for managing at least one mission management criterion for at least one aircraft mission by at least one course manager according to a preferred embodiment of the present invention.

FIG. 26 shows a front view illustrating a preferred managing screen for managing at least one flyable mission for at least one student by at least one grading instructor, according to a preferred embodiment of the present invention.

FIG. 27 shows a front view illustrating a preferred scoring screen for scoring at least one scorable event for at least one student by at least one grading instructor, according to a preferred embodiment of the present invention.

FIG. 28 shows a front view illustrating a preferred managing screen for managing at least one student management criterion for at least one course for at least one student by at least one course manager, according to a preferred embodiment of the present invention.

FIG. 29 shows a schematic view illustrating a preferred gradated scoring matrix, according to a preferred embodiment of the present invention.

FIG. 30 shows a flowchart illustrating a preferred method of the present invention.

FIG. 31 shows another flowchart illustrating another preferred method of the present invention.

FIG. 32 shows a login screen of a scorable mission manager application according to a preferred embodiment of the present application.

FIG. 33 shows a main window screen of the scorable mission manager application referred to in FIG. 32.

FIG. 34 shows an add mission screen of the scorable mission manager application referred to in FIG. 32.

FIG. 35 shows a notification screen of the scorable mission manager application referred to in FIG. 32.

FIG. 36 shows a score display screen of the scorable mission manager application referred to in FIG. 32.

### DEFINITIONS, ACRONYMS AND CROSS-REFERENCES

The following terms and acronyms are explained below as background and are used throughout the detailed description:

Actual Event Score. The value assigned to the flown mission for the event, which is either the Possible Event Score or zero.

Actual Raw Score. The sum of the Actual Event Scores in a completed scorable mission. Application Program Interface (API). The name assigned to a set of routines, protocols, and tools for building software applications. A good API makes it easier to develop a program by providing all the building blocks. A programmer puts the blocks together. Most operating environments, such as Microsoft Windows, provide an API so that programmers can write applications consistent with the operating environment. Although APIs are designed for programmers, they are ultimately good for users because they guarantee that all programs using a common API will have similar interfaces. This makes it easier for users to learn new programs. An application programming interface (API) is the interface that a computer system, library, or application provides in order to allow requests for service to be made of it by other computer programs, and/or to allow data to be exchanged between them. One of the primary purposes of an API is to describe how to access a set of functions—for example, an API might describe how to draw windows or icons on the screen using a library that has been written for that purpose. API's, like most interfaces, are abstract. Software that may be accessed via a particular API is said to implement that API. (API's are also referred to as database management functions within this specification particularly as they relate to interfacing between and exchanging data between the DBMS/database and the MSFSX. Here such API allows a non-programmer to access the MSFSX hooks and handles to obtain data feeds associated with defined Level A, Level B and Level C scoring criteria).

Cascading Style Sheet (CSS). Cascading Style Sheet (CSS) is a style sheet language used to describe the presentation of a document written in a markup language. It's most common application is to style web pages written in HTML and XHTML. The CSS specifications are maintained by the World Wide Web Consortium (W3C). CSS is used by both the authors and readers of web pages to define colors, fonts, layout, and other aspects of document presentation. It is designed primarily to enable the separation of document content (written in HTML or a similar markup language) from document presentation (written in CSS). Multiple style sheets can be imported, and alternative style sheets can be specified so that the user can choose between them. Different styles can be applied depending on the output device being used. For example, the screen version may be quite different from the printed version. This allows authors to tailor the presentation appropriately for each kind of media.

Calculated Score. The act of comparing a defined flight against predetermined grading criteria, where the grading criteria are solely based on non-direct human judgment.

Client-Server. The name assigned to a model of interaction in a distributed system in which a program at one site sends a request to a program at another site and waits for a response. The requesting program is called the “client,” and the program that responds to the request is called the “server” (or “host”). In the context of the Internet (World Wide Web), the client is typically a “Web browser” that runs on a user's computer. The program that responds to Web browser requests at a Web site is commonly referred to as a “Web server.”

Course. FS2X object that stores the number and name of a Catalog Course that student take. Courses are outside of time.

Course Manager. The name assigned to an administrative user of the system that creates and updates missions, course information and other users.

Database. One or more large structured sets of persistent data maintained upon a computer system organized and structured according to a software system defining rules for organization and rules for responding to queries to read, write, or modify data as well as provide statistical information regarding the contained data. As used herein for purposes of discussion, a database may be either a single unified system or a distributed system wherein certain database elements are located upon different systems, acting in harmony to appear as one unified database.

Data Dictionary. Data Dictionary is the documentation of the acronyms and abbreviations and terms used in this project that are not common knowledge or otherwise defined in the English language.

Date/Time Stamp. The Date and Time that a Scored Mission was recorded in the Score_Mission table or the last write time of the Mission .xml file in the Scorable_Mission table.

DBMS. Data Base Management System.

Domain Name. The “www.domain.com” portion of a Uniform Resource Locator (“URL”) is called a “domain name.” A domain name is a unique Internet alphanumeric address that identifies the virtual location of Internet resources related to a particular organization. For example, URLs containing the domain name “www.XYZ.com” might include resources related to fictionally named company XYZ.

Domain Name System (DNS). The name assigned to an Internet service that translates domain names (which are alphabetic identifiers) into IP addresses (which are numeric identifiers for machines on a TCP/IP network).

Encryption. The name assigned to translation of data into a secret code. Encryption is the most effective way to achieve data security. To read an encrypted file, you must have access to a secret key or password that enables you to decrypt it. Unencrypted data is called plain text; encrypted data is referred to as cipher text. One encryption algorithm is Advanced Encryption Standard (AES), also known as Rijndael or AES/Rijndael, which is a block cipher adopted as an encryption standard by the US government. AES was adopted by National Institute of Standards and Technology (NIST) as US FIPS PUB 197 in November 2001. Other encryption algorithms include 3DES, (a block cipher formed from the Data Encryption Standard (DES) cipher by using it three times) and RSA (an algorithm for public-key encryption widely used in electronic commerce protocols).

Endpoint. The name assigned to a point in time and space that references the center of an event.

Event. A FSX defined goal that has a pass/fail criteria.

Extensible Markup Language (XML). XML describes a class of data objects known as XML documents and partially describes the behavior of computer programs which process these documents. More specifically, XML is a restricted form of the Standard Generalized Markup Language (also known as SGML). XML documents are made up of storage units defined as entities which in turn comprise either parsed or unparsed data in the form of characters or simply a character. XML is designed and intended to improve the functionality of the Internet by providing more flexible and adaptive forms of information. XML can be used to store any kind of structured information and in such encapsulated form, pass it between different computer systems which would otherwise be unable to communicate.

Extensible Style Sheet Language (XSL). The name assigned to a specification for separating style from content when creating HTML or XML pages. The specifications work much like templates, allowing designers to apply single style documents to multiple pages. XML is the second style specification to be offered by the World Wide Web Consortium (W3C) (www.w3c.org). The first, called Cascading Style Sheets (CSS), is similar to XSL, but does not include two major XSL innovations—allowing developers to dictate the way Web pages are printed and allowing one to transfer XML documents across different applications. W3C released the first draft of XSL in August 1998, and promotes the specifications as helpful to the Web's speed, accessibility, and maintenance.

Extensible Style Sheet Language Transformations (XSLT). An XML-based language used for the transformation of XML documents. The original document is not changed; rather, a new document is created based on the content of an existing document. The new document may be serialized (output) by the processor in standard XML syntax or in another format, such as HTML or plain text. XSLT is most often used to convert data between different XML schemas or to convert XML data into Web pages or PDF documents. XSLT was produced as a result of the Extensible Style Sheet Language (XSL) development effort within W3C.

File Transport Protocol (FTP). The protocol used on the Internet for exchanging files. FTP is most commonly used to download a file from a server using the Internet or to upload a file to a server (e.g., uploading a Web page file to a server).

Flight Plan. The name assigned to a plotted course that a future flight is to follow. The course can include points of reference that contain expected times of arrival, fuel usage, etc.

FS2X. Flight Simulator Scoring Extension. Also sometimes referred to as FS²X.

Grading Instructor. User responsible for managing sections which includes adding and updating student information and reviewing the scores of students in the sections they manage.

HMI. Human Machine Interface.

Hypertext Markup Language (HTML). A standard coding convention and set of codes for attaching presentation and linking attributes to informational content within documents. During a document authoring stage, the HTML codes (referred to as “tags”) are embedded within the informational content of the document. When the Web document (or “HTML document”) is subsequently transferred from a Web server to a Web browser, the codes are interpreted by the Web browser and used to parse and display the document. In addition to specifying how the Web browser is to display the document, HTML tags can be used to create links to other websites and other Web documents (commonly referred to as “hyperlinks”). For more information on HTML, see Ian S. Graham, The HTML Source Book, John Wiley and Sons, Inc., 1995 (ISBN 0471 11894 4).

Hypertext Transport Protocol (HTTP). The standard Internet (World Wide Web) client server protocol used for the exchange of information (such as HTML documents and client requests for such documents) between a Web browser (client) and a Web server (host). HTTP includes a number of different types of messages that can be sent from the client to the server to request different types of server actions. For example, a “GET” message, which has the format GET, causes the server to return the document or file located at the specified Universal Resource Locator (URL).

HTTPS. HTTP over SSL (Secure Sockets Layer) can be best understood as a secure form of HTTP communication. Specifically, SSL is a protocol utilized for the authentication and encryption of HTTP traffic. In operation, the server and client exchange a set of encryption keys that are used to create a unique encryption key used to encrypt all data exchanged during the session.

Internet. The name assigned to a collection of interconnected (public and/or private) networks that are linked together by a set of standard protocols to form a distributed network. While this term is intended to refer to what is now commonly known as the Internet, it is also intended to encompass variations that may be made in the future, including changes and additions to existing standard protocols.

LAN. The name assigned to a Local Area Network of computer systems, typically within a building or office, permitting networking. Networking is the associated sharing of resources and files, such as application software, printers and client information, in an inter-office setting.

Level A Scoring. A pass/fail score is assigned to each event. When the student flies through the event the score is assigned. If the student misses the event no score is assigned.

Level B Scoring. Two or more event regions that are assigned different values based on the closeness to the endpoint. Multiple event regions are aggregated such that a plurality of gradations of scoring is achieved.

Level C Scoring. Scoring is based on the actions on the segments and not just the endpoints. The scoring is split into two categories. C1, the first category, is a score based on average performance between the endpoints. C2, the second category, is a score based on maximum deviations from the flight path. Actions on multiple segments are aggregated such that a plurality of gradations of scoring is achieved.

Maximum Raw Score. The name assigned to the sum of the Possible Event Scores. Microsoft.net Framework. Commonly known as simply the .NET Framework, is a software development platform created by Microsoft. The .NET Framework is a Microsoft technology that allows cross-language development and provides a large standard library of objects. Other competing approaches include cross-platform languages (e.g., Perl) using a cross-platform runtime like the Java Virtual Machine.

Mission. A FSX feature that encompasses a predefined or user defined flight path. Each mission has predefined attributes by MSFSX.

MSFSX. Microsoft's Flight Simulator 10.

MSFSX Mission. The name assigned to a MSFSX flight that comprises predefined goals and events.

MSFSX Mission Name. A text value that is easily identified with what the MFSFX Mission entails.

MSFSX Mission No. A MSFSX value that is unique for every mission.

Nav Log. The name assigned to a recording of the outcome of flying a flight plan. This includes a check against the expected values in the flight plan and the actual values recorded in the flight.

Nested Events. The name assigned to a structured event comprising 2 or more sub-regions.

Percentage Score. The Actual Raw Score divided by the Maximum Possible Score and multiplied by 100.

PHP. A server-side, cross-platform, HTML-embedded scripting language used to create dynamic web pages. The initials come from the earliest version of the program, which was called “Personal Home Page Tools”. PHP is Open Source software.

Possible Event Score. The value assigned to an Actual Event Score if the User flying the Mission Successfully triggers the MSFSX Event.

Privilege Level. An enumerated value that informs FS2X of the available use-cases for users. The value is higher for users with more privileges.

Scorable Event. An MSFSX event that has a custom action trigger attached with the description containing ScorableEvent_Description_to_Display_to_Users

Scorable Mission. A MSFSX Mission with Scorable Events and the ERAU Category GUID assigned in the ERAL.xml document located at C:\Program Files\Microsoft Games\Microsoft Flight Simulator X\Categories\ERAU.xml. The MSFSX mission must reside somewhere below the following directory: C:\Program Files\Microsoft Games\Microsoft Flight Simulator X\Missions\.

Scored Event. One of the recorded hit/miss result of a User flying a Scorable Mission.

Scored Mission. The result of flying a Scorable Mission as the Sum of Scored Events

Section. An instance of a course that has a Grading Instructor and will only be available for a school term.

Session ID. In the case of transport protocols which do not implement a formal session layer sessions are maintained by a higher level program using a method defined in the data being exchanged. For example, an HTTP exchange between a browser and a remote host may include an HTTP cookie which identifies state (such as a unique session ID), information about the user's preferences, or authorization level.

Standardized scoring. A predetermined scoring system (determined by granularizing levels of user skills) that provides user-skill ranking system based on quantitative scoring. Student. The name assigned to the lowest level of user that flies a scorable-mission and reviews their personal scores.

Structured Query Language (SQL). SQL is a standard language used to communicate with relational database management systems (such as Oracle, Sybase, Microsoft SQL Server, Access, etc.) for the purpose of performing tasks such as data insertion, deletion, update, and general query for the return of data.

Simple Object Access Protocol (SOAP). SOAP is a lightweight XML/HTTP-based protocol for the exchange of information in a decentralized distributed platform-independent environment. Fundamentally, SOAP consists of three parts. The first is an envelope that defines a framework for describing what is contained in the message and how it should be processed. The second is a set of encoding rules for expressing instances of application-defined data types. The third is a normalized convention for representing remote procedure calls and responses.

Stored Procedure. A stored procedure is a program (or procedure) which is physically stored within a database. The exact implementation of a stored procedure varies from one database to another. In most cases however, stored procedures allow for an API to be defined for a database, rather than having a client application interact with the tables and other database objects directly. Stored procedures are supported by most major database vendors in some form, but there is debate among developers about the advantages of using stored procedures. Some people use them frequently, while others prefer to avoid using them altogether. Typical uses for stored procedures include data validation, integrated into the database structure. Stored procedures used for this purpose are often called triggers. Another common use is the encapsulation of an API for some large or complex processing that might require the execution of several SQL queries, such as manipulating a large dataset to produce a summarized result.

Term. A school designated time frame such as Spring 2007 or Fall 2002. All terms are a season and year.

Transmission Control Protocol/Internet Protocol (TCP/IP). A standard Internet protocol (or set of protocols) which specifies how two computers exchange data over the Internet. TCP/IP handles issues such as packetizing, packet addressing, and handshaking and error correction. For more information on TCP/IP, see Volumes I, II and III of Comer and Stevens, Internetworking with TCP/IP, Prentice Hall, Inc., ISBNs 0 13 468505 9 (vol. I), 0 13 125527 4 (vol. II), and 0 13 474222 2 (vol. III).

Uniform Resource Locator (URL). The name assigned to a unique address which fully specifies the location of a file or other resource on the Internet. The general format of a URL is protocol://machine address:port/path/filename. The port specification is optional, and, if not entered by the user, the Web browser defaults to the standard port for whatever service is specified as the protocol. For example, if HTTP is specified as the protocol, the Web browser will use the HTTP default port. The machine address in this example is the domain name for the computer or device on which the file is located.

WAN. A Wide Area Network, such as the Internet.

World Wide Web (“Web”). Used herein to refer generally to both (1) a distributed collection of interlinked, user viewable hypertext documents (commonly referred to as “Web documents”, “Web pages”, “electronic pages” or “home pages”) that are accessible via the Internet, and (2) the client and server software components that provide user access to such documents using standardized Internet protocols. Currently, the primary standard protocol for allowing applications to locate and acquire Web documents is the Hypertext Transfer Protocol (HTTP), and the electronic pages are encoded using the Hypertext Markup Language (HTML). However, the terms “World Wide Web” and “Web” are intended to encompass future markup languages and transport protocols that may be used in place of or in addition to the Hypertext Markup Language (HTML) and the Hypertext Transfer Protocol (HTTP).

Web Services Description Language (WSDL). An XML format published for describing web services. Version V1.1 has not been endorsed by the World Wide Web Consortium (W3C), however it has released a draft for version 2, and thus endorsed by the W3C. WSDL describes the public interface to the web service. This is an XML-based service description on how to communicate using the web service; namely, the protocol bindings and message formats required to interact with the web services listed in its directory. The supported operations and messages are described abstractly, and then bound to a concrete network protocol and message format. WSDL is often used in combination with SOAP and XML schema to provide web services over the Internet. A client program connecting to a web service can read the WSDL to determine what functions are available on the server. Any special data types used are embedded in the WSDL file in the form of XML Schema. The client can then use SOAP to actually call one of the functions listed in the WSDL.

Web host. A business that provides server space, web services, and file maintenance for websites controlled by individuals or companies that do not have their own web-servers.

### DETAILED DESCRIPTION OF THE BEST MODES AND PREFERRED EMBODIMENTS OF THE INVENTION

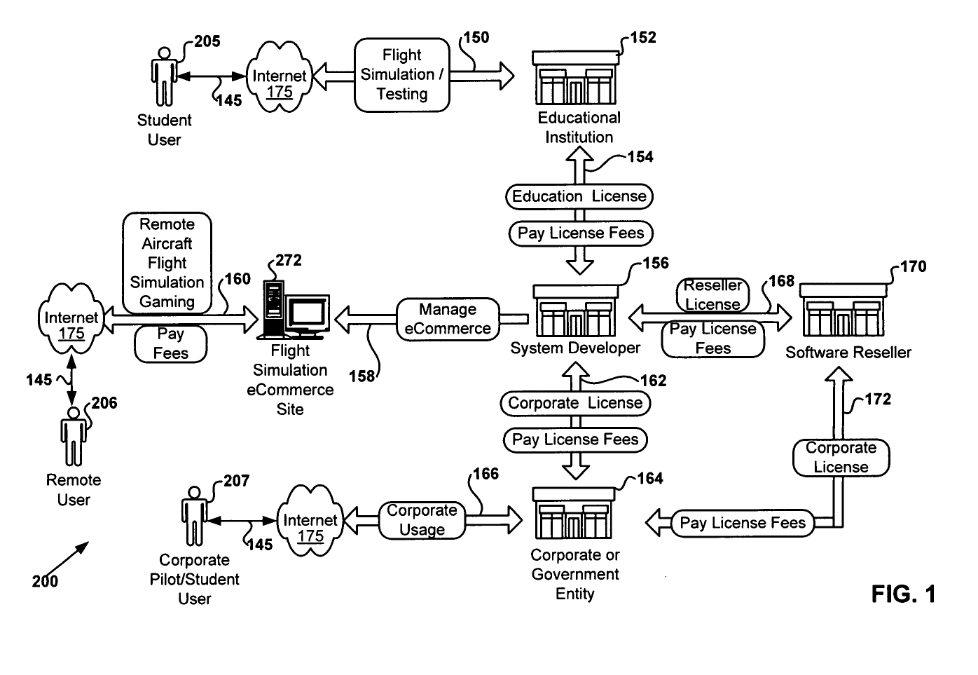

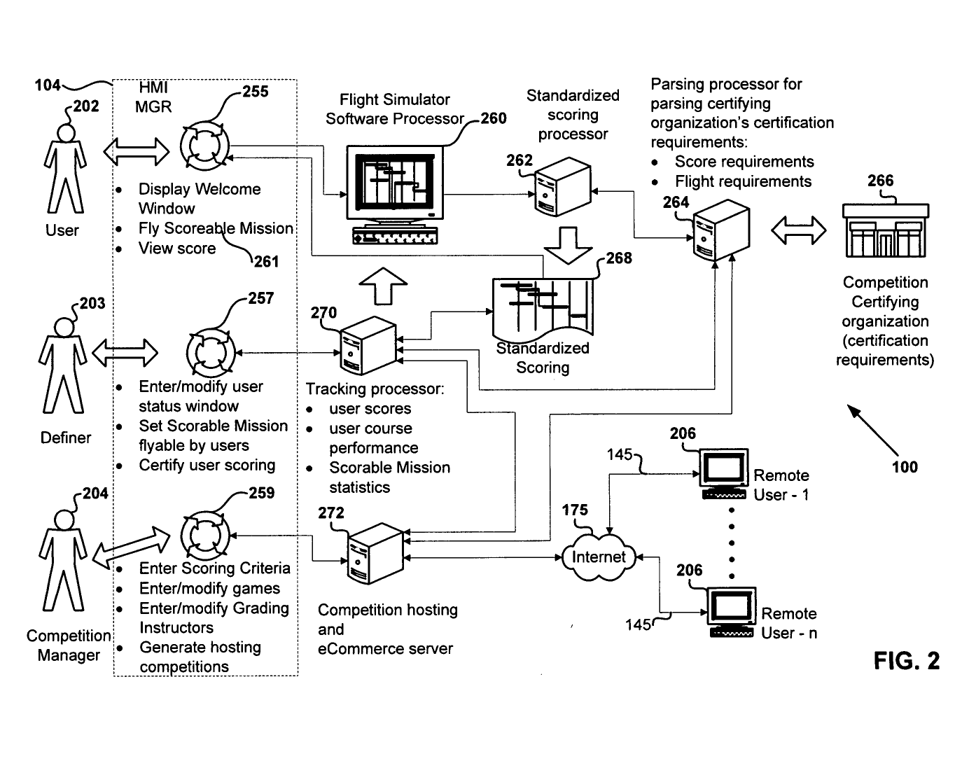

FIG. 1 shows an overall schematic illustration of a method for aircraft electronic flight-mission simulation and scoring systems, according to a preferred embodiment of the present invention. As depicted in FIG. 1, preferably, method 200 for aircraft electronic flight-mission simulation and scoring system 100 (see FIG. 2) includes system developer 156 providing educational institution license 154 to educational institution 152, as shown. In return, educational institution 152 provides license fees, as shown, to system developer 156. This educational institution license 154 preferably enables connecting of educational institution license 154 to student user 205, preferably by connection 145 to Internet 175, and preferably facilitating student user 205, preferably using aircraft electronic flight-mission simulation and scoring system 100, as shown.

Additionally preferably, method 200 for aircraft electronic flight-mission simulation and scoring system 100 comprises a preferred step of system developer 156 providing corporate or government entity license 162 for corporate or government entity 164. In return, corporate or government entity 164 preferably provides license fees, as shown, to system developer 156. This corporate license 162 preferably enables connecting of corporate or government entity 164 to corporate pilot/student user 207, preferably by connection 145 to Internet 175, and preferably facilitating corporate pilot/student user 207, preferably using aircraft electronic flight-mission simulation and scoring system 100, as shown.

Further preferably, method 200 for aircraft electronic flight-mission simulation and scoring system 100 includes system developer 156 providing reseller license 168 to software retailer 170 in return for software retailer 170 providing reseller license fees, as shown, to system developer 156. Software retailer 170 preferably links to corporate or government entity 164, providing corporate license 172 in return for corporate or government entity 164 providing license fees, as shown, to software retailer 170. This corporate license 172 preferably enables connecting of corporate or government entity 164 to corporate pilot/student user 207, preferably by connection 145 to Internet 175, and preferably facilitating corporate pilot/student user 207, preferably using aircraft electronic flight-mission simulation and scoring system 100, as shown.

Further additionally preferably, method 200 for aircraft electronic flight-mission simulation and scoring system 100 includes directly commercializing use of at least one simulated-aircraft-piloting platform by the following preferred steps: system developer 156 providing eCommerce license 158 to eCommerce site 272 in return for eCommerce site 272 providing eCommerce license fees 160, as shown, to system developer 156; and eCommerce site 272 preferably then providing eCommerce license fees 160, as shown, to remote user 206 in return for remote user 206 providing license fees to eCommerce site 272 (at least embodying herein the step of receiving monetary value, from such at least one user, as at least one condition for such at least one user being identified as an authorized user). It is noted that such direct monetizing includes other herein mentioned techniques, such as pay-for-play subscriptions. Upon reading the teachings of this specification, those with ordinary skill in the art will now understand that, under appropriate circumstances, considering issues such as changes in technology, user requirements, etc., other monetizing service oriented architectures, such as, for example, monetizing peer-to-peer network architectures, billing and settlement architectures yet to be developed, etc., may suffice. This preferably enables remote user 206 to connect to eCommerce site 272 preferably by Internet 175, and preferably enables remote user 206 to connect with aircraft electronic flight-mission simulation and scoring system 100, as shown.

FIG. 2 shows a schematic illustration of operational functions of a business method for aircraft electronic flight-mission simulation and scoring system 100, according to a preferred embodiment of the present invention. User 202, also representing student user 205 or remote user 206 or corporate pilot/student user 207, utilizes HMI (human machine interface) manager 104 to interface with aircraft electronic flight-mission simulation and scoring system 100, as shown. User interface 255 preferably provides user 202 with a welcome window, fly-scorable-mission display and view-score window, as shown. Utilizing user interface 255, preferably enables user 202 to access flight simulator software processor 260 and fly at least one scorable mission of at least one simulated aircraft, as shown.

Standardized scoring processor 262 (at least embodying herein the step including generating multiple quantitative scoring levels of each of such plurality of scorable events; and at least embodying herein at least one system adapted to generate multiple quantitative scoring levels of each of such plurality of scorable events) preferably scores performance of user 202 as user 202 flies at least one scorable mission of at least one simulated aircraft, as shown. Preferably the scores of performance of user 202 comprise quantitative Level A scoring, Level B scoring, and Level C scoring and further provide a basis for competitive ranking of the relative performance of multiple users 202, as well as the ranking of relative performance of multiple simulated flights of the same user 202 (at least embodying herein the step of providing at least one competitive user ranking based upon standardized scoring, wherein competition may be related to levels of skill). Upon reading the teachings of this specification, those with ordinary skill in the art will now understand that, under appropriate circumstances, considering issues such as changes in technology, user skills, aircraft flight simulation requirements, etc., other multi-tier quantitative performance scoring methods, such as, for example, ranked-scoring of analog metrics, statistically-ranked scoring of digital metrics, yet to be developed, etc., may suffice.

Further, standardized scoring processor 262 preferably obtains at least one scoring criterion, from parsing processor 264, for parsing at least one certification requirement (consisting of flight mission requirements and related score requirements) based on at least one certification requirement of certifying organization 266, where such certifying organization is a recognized certification organization for pilots of aircraft (at least embodying herein the step of simulating at least one certification requirement of at least one real-flight certification of at least one real-life certifying organization). Tracking processor 270 obtains standardized scoring 268 from standardized-scoring processor 262, for the performance of user 202, as user 202 flies at least one scorable mission of at least one simulated aircraft, as shown. Tracking processor 270 also obtains scoring criteria from parsing processor 264, such that tracking processor 270 can compare the performance of user 202 to certification requirements of certifying organization 266.

Definer 203, also representing grading instructor 208, utilizes HMI manager 104 to interface with aircraft electronic flight-mission simulation and scoring system 100, as shown. User interface 257 preferably provides definer 203 with an enter/modify user status window, set scorable mission flyable by users window, and certify user scoring window, as shown. Utilizing user interface 257 definer 203 preferably accesses tracking processor 270 and tracks the status of user 202 scores, user 202 flyable missions, user 202 courses, and related scorable mission statistics, as shown.

Competition manager 204, also representing course manager 209, utilizes HMI manager 104 to interface with aircraft electronic flight-mission simulation and scoring system 100, as shown. User interface 259 preferably provides competition manager with an enter scoring-criteria window, enter/modify flyable-mission window, enter/modify grading-instructors window, and generate hosting-competitions window, as shown. Utilizing user interface 259 competition manager 204 preferably accesses competition hosting and ecommerce processor 272 and tracks the status of competitions of at least two user 202 scores, user 202 flyable missions, user 202 competitions, and related scorable competition statistics, as shown.

Additionally tracking processor 270 preferably processes authorizing information, as shown, for user 202 from user interface 255 regarding information necessary to establish a level of authorization required for user 202 to utilize aircraft electronic flight-mission simulation and scoring system 100, as shown (at least embodying herein the step of establishing at least one identifiable attribute, of such at least one user, as at least one condition for such at least one user being identified as an authorized user). Upon reading the teachings of this specification, those with ordinary skill in the art will now understand that, under appropriate circumstances, considering issues such as changes in technology, user requirements, etc., other authorization architectures, such as, for example, public key based authorization architectures, attribute-server based authorization architectures yet to be developed, etc., may suffice.

Tracking processor 270 preferably processes user 202 authenticating information from user interface 255 regarding the identity of user 202, which preferably correlates with at least one unique attribute of user 202. Upon reading the teachings of this specification, those with ordinary skill in the art will now understand that, under appropriate circumstances, considering issues such as changes in technology, customer requirements, etc., other human-attribute authenticating architectures, such as, for example, eye-retina based architectures, palm-print based architectures yet to be developed, etc., may suffice.

Tracking processor 270 preferably processes user 202 authenticating information from user interface 255 regarding the identity of user 202, which preferably correlates with at least one physical object in the possession of user 202 and uniquely relatable to such one user.

Tracking processor 270 preferably processes user 202 authenticating information from user interface 255 regarding the identity of user 202 which correlates with at least one element-of-knowledge uniquely known by user 202 and relatable to user 202. Upon reading the teachings of this specification, those with ordinary skill in the art will now understand that, under appropriate circumstances, considering issues such as changes in technology, customer requirements, etc., other element-of-knowledge based architectures, such as, for example, pseudo-random generator based architectures, numerical-correlation based architectures yet to be developed, etc., may suffice.

Tracking processor 270 preferably processing cryptographic privacy services for user 202 during the transmitting monetary value to and from user 202 necessary for user 202 to utilize aircraft electronic flight-mission simulation and scoring system 100, as shown. Upon reading the teachings of this specification, those with ordinary skill in the art will now understand that, under appropriate circumstances, considering issues such as changes in technology, customer requirements, etc., other cryptographic architectures, such as, for example, hash-function based architectures, block-cipher based architectures yet to be developed, etc., may suffice.

Tracking processor 270 preferably processing cryptographic privacy services for user 202 regarding information transmitted to and from user 202 necessary for user 202 to utilize aircraft electronic flight-mission simulation and scoring system 100, as shown. Upon reading the teachings of this specification, those with ordinary skill in the art will now understand that, under appropriate circumstances, considering issues such as changes in technology, customer requirements, etc., other cryptographic architectures, such as, for example, hash-function based architectures, block-cipher based architectures yet to be developed, etc., may suffice.

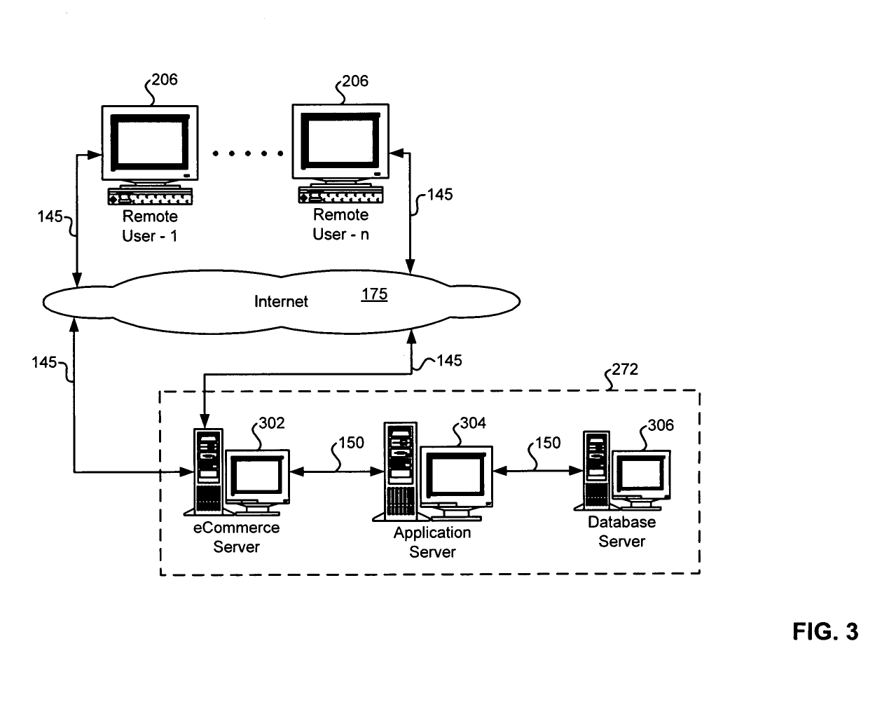

FIG. 3 shows a schematic illustration of a preferred web-based electronic commerce system, according to a preferred embodiment of the present invention. This figure shows the preferred relationships between remote user 206 (as an example of any number of remote users of aircraft electronic flight-mission simulation and scoring system 100), Internet 175, eCommerce server 302, application server 304, and database server 306 (such servers at least embodying herein virtual-platform processing means for simulating aircraft piloting on at least one computational platform). As shown, remote user 206 requests a page from eCommerce server 302 where a preferred embodiment of the present invention is preferably located. Remote user 206 is preferably connected via Internet 175 to eCommerce server 302, which receives a web page request (from remote user 206) and initiates a call to application server 304. Upon reading the teachings of this specification, those with ordinary skill in the art will now understand that, under appropriate circumstances, considering issues such as changes in technology, user requirements, etc., other commercially available personal computer-based devices, such as, for example, a handheld computer, a PDA (personal digital assistant), a wireless or wired phone with HTTP capabilities or similar capabilities and protocols yet to be developed, etc., may suffice.

As shown, a preferred embodiment of the present invention installed on application server 304 then makes at least one request to database server 306 and generates at least one HTML page for transmission to remote user 206 following completion of the present invention's request and transmission of the requested data back to the application server 304 by database server 306. eCommerce server 302 then transmits the completed HTML page containing the data requested by remote user 206 through Internet 175 to remote user 206.

As shown, eCommerce server 302, application server 304 and database server 306 together comprise eCommerce site 272 (at least embodying herein the step of providing at least one simulated-aircraft-piloting platform; and further at least embodies herein at least one simulated-aircraft-piloting platform). Upon reading the teachings of this specification, those with ordinary skill in the art will now understand that, under appropriate circumstances, considering issues such as changes in technology, customer requirements, etc., other eCommerce architectures, such as, for example, three-tier architectures with transaction monitoring capability, three-tier architectures with message server capability, three-tier architectures with object request broker capability, similar n-tier architectures yet to be developed, etc., may suffice.

Connection 150 is typically a TCP-IP connection, or other connection, which permits communication between application server 304 and database server 306 and between application server 304 and eCommerce server 302. Connection 145 is typically TCP-IP and permits remote user 206 to communicate with eCommerce server 302. Upon reading the teachings of this specification, those with ordinary skill in the art will now understand that, under appropriate circumstances, considering issues such as changes in technology, customer requirements, etc., other network (IP) and transport (TCP) protocols, such as, for example, IPX (internet work packet exchange) and UDP (user datagram protocol), similar network and transport protocols yet to be developed, etc., may suffice.

Referring again to FIG. 3, access from Internet 175 to eCommerce server 302 is preferably via the HTTP or HTTPS protocol and is restricted to a specific TCP port (e.g., port 8080) on eCommerce server 302 (to port 8083 when using SSL). Using a hardware firewall the first point of entry preferably can be further restricted to specific port (e.g., port 80) and a set of IP address ranges. The database can run on the same server as application server 304. Alternatively, preferably a cluster of two or more servers may run the application server 304 along with a separate server for the database. Upon reading the teachings of this specification, those with ordinary skill in the art will now understand that, under appropriate circumstances, considering issues such as changes in technology, customer requirements, etc., other communication architectures, such as, for example, local area network architectures, wide area network architectures yet to be developed, etc., may suffice.

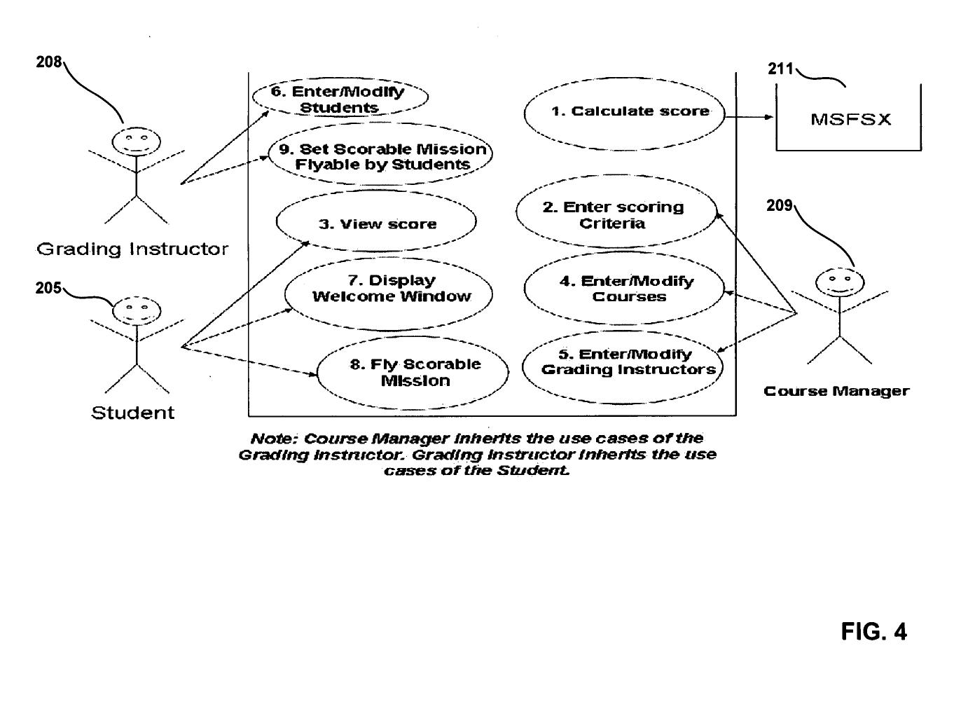

FIG. 4 shows a schematic view illustrating preferred use-cases, according to the preferred embodiment of the present invention. Referring to FIG. 4, preferably the primary actors (student 205, grading instructor 208 and course manager 209) and use-cases, are shown for preferred aircraft electronic flight-mission simulation and scoring system 100.

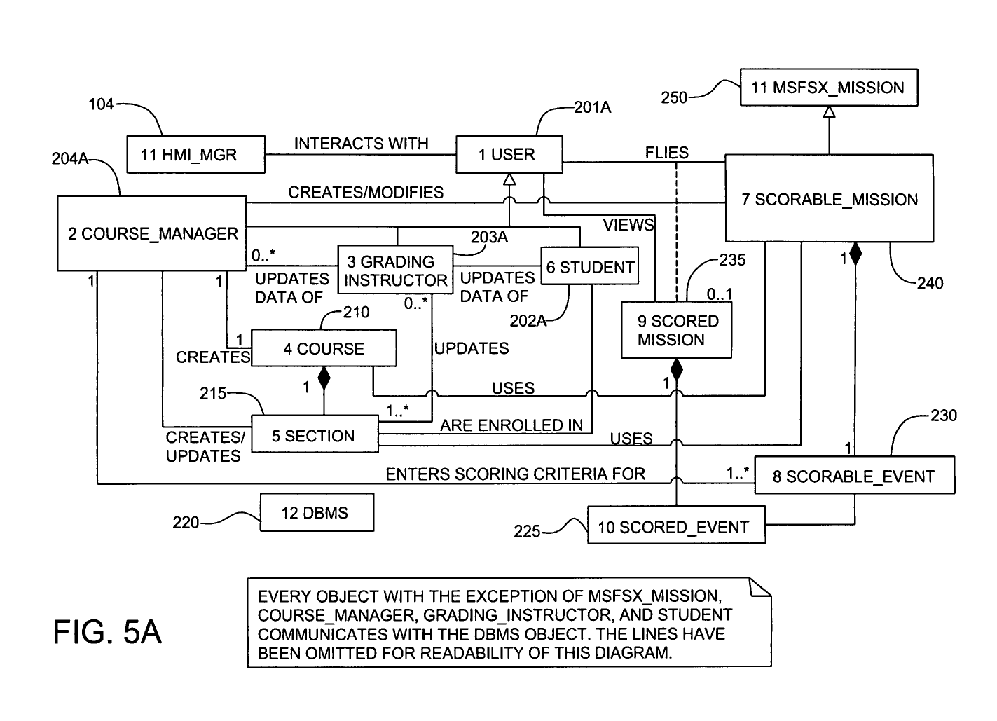

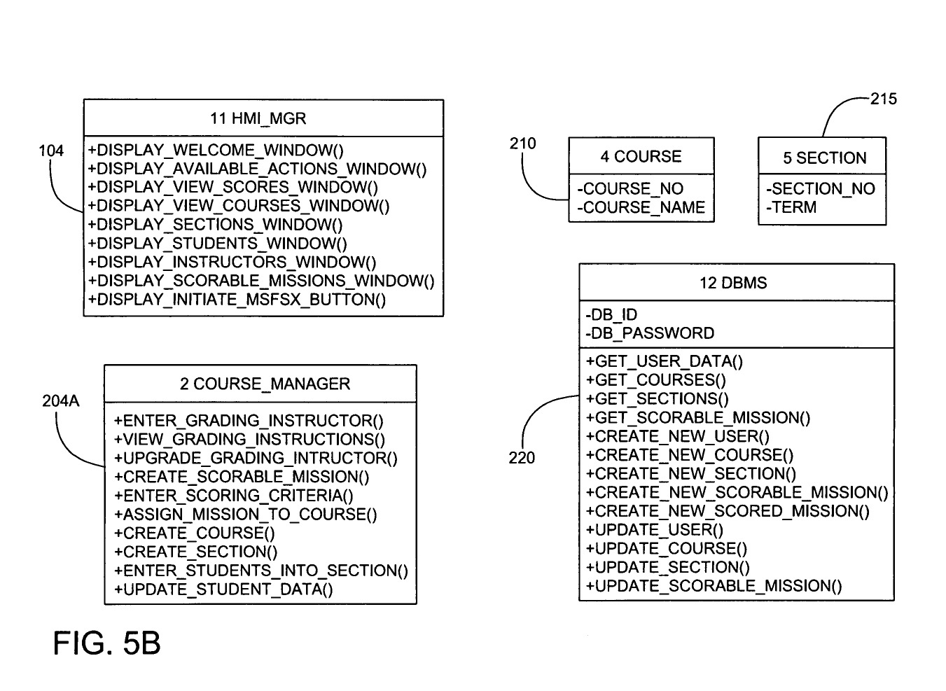

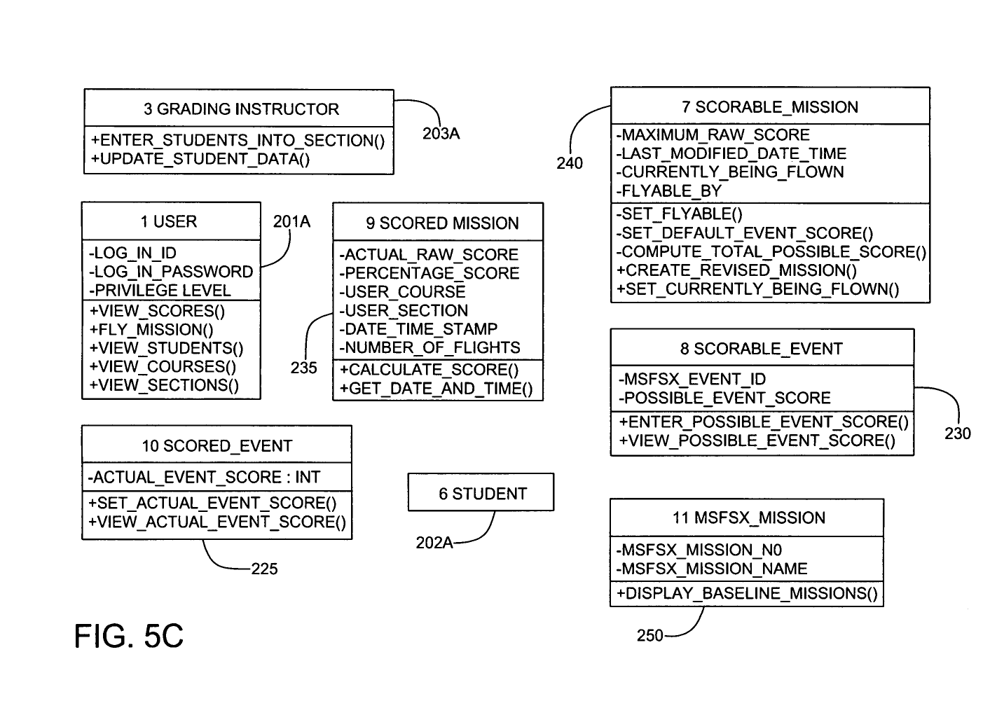

FIG. 5A, FIG. 5B, and FIG. 5C together show a schematic view illustrating a preferred domain object model, according to a preferred embodiment of the present invention. The following objects are preferably supported as shown in FIG. 5A, FIG. 5B, and FIG. 5C: 1 User 201A, 2 Course_Manager 204A, 3 Grading Instructor 203A, 4 Course 210, 5 Section 215, 6 Student 202A, 7 Scorable_Mission 240, 8 Scorable_Event 230, 9 Scored Mission 235, 10 Scored_Event 225, 11 HMI_MGR 104, 11 MSFSX_Mission 250, 12 DBMS 220, as shown.

Object User 201A preferably interacts with the following: HMI_MGR 104, DBMS 220 to stores its information, Flies Scorable_Missions, View Scored_Missions, and has one and only one child of either Course_Manager, Grading_Instructor, or Student.

Object User 201A has the following associated attributes: LOG_IN_ID, LOG_IN_PASSWORD, and PRIVILEGE LEVEL, as shown in FIG. 5C. User 201A is an upper level object that stores the abilities and actions of all users in FS2X. The attribute LOG_IN_ID is a reference to the User. This LOG_IN_ID must be used in order to log in a User and also to identify User 201A to the DBMS for searching. Attribute LOG_IN_PASSWORD is the password hash associated with the LOG_IN_ID attribute. This attribute is used to check the authenticity of the User. The attribute PRIVILEGE_LEVEL is used by the DBMS to easily check the type of User that has inherited this object. Preferably, an enumerated value is associated with each type of user, for example, Course_Manager=3, Grading_Instructor=2, and Student=1.

Object User 201A may perform the following actions. Some actions are preferably privileged depending on the user status. Action View_Score initiates Use Case 3: View Scores. Action Fly_Mission initiates Use Case 8: Fly Scorable Mission. Action View_Students is used in any use case where user information is viewed (Use Case 3: View Score, Use Case 5: Enter/Modify Grading_Instructors, Use Case 6: Enter/Modify Students, and Use Case 9: Set Scorable Mission Flyable by Students). Action View_Courses is preferably used in any use case where course information may be viewed (Use Case 3: View Score, Use Case 4: Enter/Modify Courses, Use Case 6: Enter/Modify Students, and Use Case 9: Set Scorable Mission Flyable by Students). It is noted that when a Section is displayed the associated is also preferably displayed. Action VIEW_SECTIONS is used in any use case where Sections Information is viewed (Use Case 3: View Score, Use Case 4: Enter/Modify Courses, Use Case 6: Enter/Modify Students, and Use Case 9: Set Scorable Mission Flyable by Students).

Course_Manager Object 204A is the administrative figure to FS²X. The Course_Manager has all the capabilities of Grading_Instructors and Students. Table 1 below summarizes the attributes, actions, and interactions of Course_Manager object 204A.

TABLE 1
Object 2: Course_Manager 204A Attributes, Actions, and Interactions

| | | |
|---|---|---|
| Attributes | Inherited from the User | |
| Actions | Enter_Grading_Instructor | Inputs User into FS2X with |
| | | the Privilege_Level set to |
| | | Grading_Instructor |
| | View_Grading_Instructor | View_Grading_Instructor is |
| | | used to get the User data of a |
| | | user with a Privilege_Level of |
| | | Grading_Instructor. The |
| | | Course_Manager will be able |
| | | to see all Grading_Instructors |
| | Update_Grading_Instructor | Update_Grading_Instructor is |
| | | used to change the User data |
| | | of a User with a |
| | | Privilege_Level of |
| | | Grading_Instructor. The |
| | | Course_Manager will be able |
| | | to update all |
| | | Grading_Instructors. |
| | Create_Scorable_Mission | Create_Scorable_Mission is |
| | | used to create a blank shell of |
| | | a Scorable_Mission then |
| | | FS2X goes directly into |
| | | Modify_Scorable_Mission to |
| | | put usable data into the newly |
| | | created Scorable_Mission. |
| | Modify_Scorable_Mission | Modify_Scorable_Mission |
| | | updates the information stored |
| | | in a Scorable_Mission |
| | Enter_Scoring_Criteria | Enter_Scoring_Criteria is how |
| | | the Default_Event_Score or |
| | | Course_Manager modified |
| | | Possible_Event_Score is |
| | | stored in a Scorable_Event. |
| | Assign_Mission_to_Course | Assign_Mission_to_Course is |
| | | the linking of a |
| | | Scorable_Mission to a Course. |
| | | At the point a Mission is |
| | | assigned to a Course it can be |
| | | flown by Grading_Instructors |
| | | that are teaching connected to |
| | | Sections that are connected to |
| | | the Course which the Mission |
| | | was assigned. |
| | Create_Course | Create_Course creates a new |
| | | instance of a Course in FS2X. |
| | | The new Course is then |
| | | updated with usable data. |
| | Create_Section | Create_Section creates a new |
| | | instance of a Section in FS2X. |
| | | The new Section is then |
| | | updated with usable data. |
| | Enter_Students_Into_Section | Enter_Students_Into_Section |
| | | enrolls Students into a |
| | | Section. |
| | Update_Student_Data | Update_Student_Data allows |
| | | the Course_Manager to |
| | | change the User Attributes of any User with |
| | | the Privilege_Level of Student. |

| | |
|---|---|
| Interactions | Course_Manager is a child of a User that Creates/Modifies |
| | Courses, Sections, Grading_Instructors, Students, and |
| | Scorable_Missions. Course_Managers also enter the scoring |
| | criteria into Scorable_Events. |

Grading_Instructor Object 203A is a type of User that is responsible for Sections and the Students in those Sections. Table 2 below summarizes the attributes, actions, and interactions of Grading_Instructor Object 203A.

TABLE 2
Object 3: Grading_Instructor Attributes, Actions, and Interactions
Grading_Instructor

| | | |
|---|---|---|
| Attributes | Inherited from the User | |
| Actions | Enter_Students_Into_Section | Enter_Students_Into_Section |
| | | enrolls Students into a |
| | | Section. |
| | Update_Student_Data | Update_Student_Data allows |
| | | the Grading_Instructor to |
| | | change the User Attributes of any User |
| | | with the Privilege_Level of Student. |

| | |
|---|---|
| Interactions | Grading_Instructor is a child of a User that updates one or more |
| | Sections and Students. |

Course Object 210 preferably refers to perpetual entities that are active regardless of time. Courses are the part of a class offered on campus that does not change with semesters. Table 3 summarizes the attributes, actions, and interactions of Course Object 210.

TABLE 3
Object 4: Course Object 210 Attributes, Actions, and Interactions

| | | |
|---|---|---|
| Attributes | Course_No | Course_No is the |
| | | alphanumeric number |
| | | assigned to a Course in a |
| | | school Course Catalog such as |
| | | AS125. |
| | Course_Name | Course_Name is a character |
| | | string that describes the |
| | | Course_No to the rest of the |
| | | world. An example would be |
| | | Human Computer Interfaces is |
| | | the Course Name for the |
| | | Course_No CS415. |

| | |
|---|---|
| Actions | Course has no direct actions |
| Interactions | Course has Sections and uses |
| | Scorable_Missions. |

Section Object 215 preferably refers to dependent entities that are active only for a semester and after that are stored for archival purposes. Table 4 summarizes the attributes, actions, and interactions of Section Object 215.

TABLE 4
Object 5: Section Object 215 Attributes, Actions, and Interactions

| | | |
|---|---|---|
| Attributes | Section_No | Section_No refers to the |
| | | appended number to a |
| | | Course_No. The number |
| | | references the instance of that |
| | | Course for the Semester. A |
| | | Class can be AS125.02 the |
| | | “.02” is the Section_No. |
| | Term | Term is the time in which the |
| | | Section is assigned. An |
| | | example would be Fall 2007 |
| | | or Summer A 2010. |

| | |
|---|---|
| Actions | Section has no direct actions |
| Interactions | Sections are connected to Courses and have at |
| | least one Student enrolled. Sections connect |
| | Students to Scorable_Mission when the |
| | Grading_Instructor sees it fit to allow the |
| | Students to fly the Scorable_Mission. |

Table 5 summarizes the attributes, actions, and interactions of Student Object 202A.

TABLE 5
Object 6: Student Object 202A Attributes, Actions, and Interactions

| | |
|---|---|
| Attributes | The only attributes the Student has are inherited from |
| | the User. |
| Actions | The only actions the Student has are inherited from the |
| | User. |
| Interactions | Student is a child of a User that is enrolled in a Section |
| | in the manner that a Section has at least one Student |

Scorable_Mission Object 240 is an extension of an MSFSX_Mission. The Scorable_Mission has the attributes, actions and interactions that allow FS²X to score an MSFSX_Mission. Table 6 summarizes the attributes, actions, and interactions of Scorable_Mission Object 240.

TABLE 6
Object 7: Scorable_Mission Object 240 Attributes, Actions, and Interactions

| | | |
|---|---|---|
| Attributes | Maximum_Raw_Score | Maximum_Raw_Score is the |
| | | sum of all |
| | | Possible_Event_Scores or the |
| | | point value of a 100%. |
| | Last_Modified_Date_Time | Last_Modified_Date_Time is |
| | | the last time the |
| | | MSFSX_Mission file was |
| | | modified. This is to check and |
| | | make sure the Mission that is |
| | | being given to the students to |
| | | fly is the one that has the |
| | | grading criteria. |
| | Currently_Being_Flown | Currently_Being_Flown is a |
| | | reference that can be set so that |
| | | if a Mission is in flight the |
| | | Course_Manager cannot change |
| | | the scoring data. |
| | Flyable_by | Flyable_by is a phrase that |
| | | leads into the value stored in it. |
| | | When Flyable_by is set to |
| | | Grading_Instructors the |
| | | Scorable_Mission can be flown |
| | | by Grading_Instructors that are |
| | | responsible for a Section that is |
| | | connected with the |
| | | Scorable_Mission. Once |
| | | Flyable_by is set to Students |
| | | the Scorable_Mission can be |
| | | flown by anyone that is |
| | | connected to it. |
| Actions | Set_Flyable | The following is a list of |
| | | actions associated with Object |
| | | Scorable_Mission: |
| | | Set_Flyable sets the Flyable_by |
| | | attribute to Grading_Instructor, |
| | | Student or No_One. |
| | Set_Default_Event_Score | Set_Default_Event_Score takes |
| | | in a value from the |
| | | Course_Manager and applies it |
| | | to all Scorable_Events for that |
| | | Scorable_Mission. |
| | Compute_Total_Possible_Score | Compute_Total_Possible_Score sums |
| | | the values in |
| | | Possible_Event_Score in the |
| | | Scorable_Events that belong to |
| | | the Scorable_Mission. The |
| | | result is stored in |
| | | Maximum_Raw_Score. |
| | Create_Revised_Mission | Create_Revised_Mission is |
| | | used when the |
| | | Last_Modified_Date_Time |
| | | does not match the file or a |
| | | Possible_Event_Score is |
| | | changed after a Student has |
| | | flown the Scorable Mission. |
| | Set_Currently_Being_Flown | Set_Currently_Being_Flown |
| | | controls the value in the |
| | | Currently_Being_Flown |
| | | attribute. |

| | |
|---|---|
| Interactions | Scorable_Missions have one or more Scorable_Events. |
| | Scorable_Missions are children of MSFSX_Missions that are |
| | flown by Users, Created/Modified by Course_Managers, Used by |
| | Courses and Sections, and contain data for Scored_Missions when |
| | flown. |

Scorable_Event Object 230 is a part of the mission that has an individual value summed together makes a Scorable_Mission, like a question on a test. The Scorable_Event is any MSFSX action that can create a trigger. The action can be anything from passing through a region of space at a give time to an airspeed value. Table 7 summarizes the attributes, actions, and interactions of Scorable_Event Object 230.

TABLE 7
Object 8: Scorable_Event Object 230 Attributes, Actions, and Interactions

| | | |
|---|---|---|
| Attributes | MSFSX_Event_ID | MSFSX_Event_ID is a five part hexadecimal |
| | | number with 8 |
| | | digits in the first part 4 digits in |
| | | the 2, 3 and 4th part and 12 in |
| | | the 5th part. The |
| | | MSFSX_Event_ID is a unique |
| | | identifier for every object in |
| | | any MSFSX_Mission. An |
| | | example of a valid |
| | | MSFSX_Event_ID is |
| | | “F3F1563B-0F11-4B82-B00D- |
| | | 2F08B5F07C87.” |
| | Possible_Event_Score | Possible_Event_Score is the |
| | | value that is stored in the |
| | | Actual_Event_Score attribute |
| | | of Scored_Event if the User |
| | | triggers the MSFSX_Event. |
| Actions | Enter_Possible_Event_Score | Enter_Possible_Event_Score is |
| | | used to store a value into the |
| | | Possible_Event_Score attribute. |
| | | The value should be a positive |
| | | number. |
| | View_Possible_Event_Score | View_Possible_Event_Score |
| | | retrieves the value stored in |
| | | Possible_Event_Score for |
| | | viewing by the user or for |
| | | storing in a Scored_Event. |

| | |
|---|---|
| Interactions | Scorable_Events are connected to a Scorable_Mission |
| | and have children of Scored_Events |

Scored_Mission Object 235 is created to store the grade when a Scorable_Mission is flown, or performed. All the data required to review a score at a later data is stored in the Scored_Mission Object. Table 8 summarizes the attributes, actions, and interactions of Scored_Mission Object 235.

TABLE 8
Object 9: Scored_Mission Object 235 Attributes, Actions,
and Interactions

| | | |
|---|---|---|
| Attributes | Actual_Raw_Score | Actual_Raw_Score is the |
| | | summed value of the |
| | | Actual_Event_Score attributes |
| | | in the attached Scored_Events. |
| | Percentage_Score | Percentage_Score is the result |
| | | of the Actual_Raw_Score |
| | | divided by the |
| | | Maximum_Raw_Score |
| | | attribute of the |
| | | Scorable_Mission |
| | | multiplied by 100. |
| | User_Course | User_Course is the Course_No |
| | | and Name that the |
| | | Scorable_Mission was flown. |
| | User_Section | User_Section is the Section_No |
| | | and Term that the User was |
| | | connected. |
| | Date_Time_Stamp | Date_Time_Stamp is the Data |
| | | and Time that the |
| | | Scorable_Mission was flown. |
| | Number_of_Flights | Number_of_Flights store the |
| | | flight number of this particular |
| | | Scorable_Mission. If it is the |
| | | first time the User has flown the |
| | | Scorable_Mission the attribute |
| | | will contain a 1. |
| Actions | Calculate_Score | Calculate_Score computes the |
| | | values to be stored in |
| | | Actual_Raw_Score and |
| | | Percentage_Score and stores |
| | | them. |
| | Get_Date_Time_Stamp | Get_Date_Time_Stamp returns |
| | | the Date_Time_Stamp |

| | |
|---|---|
| Interactions | Scored_Mission has one or more Scored_Events |
| | and is created when a User flies a Scorable_Mission. |
| | Scored_Mission is viewed by the User that flies |
| | it and the Grading Instructor that assigns the |
| | Scorable_Mission. |

Scored_Event Object 225 preferably stores the results of the pass/fail criteria of hitting an event in a flown Scorable_Mission. Table 9 summarizes the attributes, actions, and interactions of Scored_Event Object 225.

TABLE 9
Object 10: Scored_Event Object 225 Attributes, Actions, and Interactions

| | | |
|---|---|---|
| Attributes | Actual_Event_Score | Actual_Event_Score is the value of the |
| | | Possible_Event_Score attribute |
| | | from the Scorable_Event that |
| | | the Scored_Event is a child of |
| | | or value is zero. |
| Actions | Set_Actual_Event_Score | Set_Actual_Event_Score sets |
| | | the value of |
| | | Actual_Event_Score |
| | View_Actual_Event_Score | View_Actual_Event_Score |
| | | outputs the value of |
| | | Actual_Event_Score |

| | |
|---|---|
| Interactions | Score_Event is a part of a Scored_Mission and a child of a |
| | Scorable_Event. |

HMI_MGR Object 104 preferably contains the actions necessary for a User to communicate his/her needs to FS²X. Table 10 summarizes the attributes, actions, and interactions of HMI_MGR Object 104.

TABLE 10
Object 11: HMI_MGR Object 104 Attributes, Actions, and Interactions

| | | |
|---|---|---|
| Attributes | No attributes. | |
| Actions | Display_Welcome_Window | Display_Welcome_Window is an |
| | | opening screen that handles |
| | | authenticating the User. |
| | Display_Available_Actions_Window | Display_Available_Actions_Window |
| | | is the post authentication window |
| | | with the list of available action the |
| | | User has the privilege to perform. |
| | Display_View_Scores_Window | Display_View_Scores_Window is |
| | | the window that shows the scores |
| | | recorder from flying missions. |
| | Display_Courses_Window | Display_Courses_Window is the |
| | | window used by the Course_Manager |
| | | to Enter/Modify Courses |
| | Display_Sections_Window | Display_Sections_Window is used |
| | | by the Grading_Instructor to |
| | | Enter/Modify Students as well as Set |
| | | Missions flyable by Students. |
| | Display_Students_Window | Display_Students_Window shows |
| | | the relevant students to the |
| | | Grading_Instructor when updating |
| | | their information. |
| | Display_Instructors_Window | Display_Instructors_Window shows |
| | | all Grading_Instructors to the |
| | | Course_Manager for updating the |
| | | Grading_Instructor's attributers |
| | Display_Scorable_Missions_Window | Display_Scorable_Missions_Window |
| | | shows a list of Scorable_Missions |
| | | and MSFSX_Mission in order to |
| | | update and create Scorable_Missions. |
| Interactions | HMI_MGR connects the User to FS²X. | |

DBMS Object 220 is preferably responsible for creating, storing and maintaining all perpetual data in FS²X. Table 11 summarizes the attributes, actions, and interactions of DBMS Object 220.

TABLE 11
Object 12: DBMS Object 220 Attributes, Actions, and Interactions

| | | |
|---|---|---|
| Attributes | DB_ID | DB_ID is the login ID to access the |
| | | database. |
| | DB_Password | DB_Password is the password to |
| | | access the database |
| Actions | Get_User_Data | Get_User_Data returns the current |
| | | values stored in the User object |
| | | requested. |
| | Get_Courses | Get_Courses returns the current |
| | | Course_No and Course_Name for the |
| | | requested object |
| | Get_Sections | Get_Sections returns the current |
| | | Section_No and Term for the |
| | | requested object |
| | Get_Scorable_Mission | Get_Scorable_Mission returns the |
| | | current Scorable_Mission attributes |
| | | for the selected object. |
| | Get_Scored_Mission | Get_Scored_Mission returns the |
| | | current Scored_Mission attributes for |
| | | the selected object. |
| | Create_New_User | Create_New_User creates an |
| | | initialized object of class User. |
| | Create_New_Courses | Create_New_Courses creates a new |
| | | initialized object of class Course |
| | Create_New_Sections | Create_New_Sections creates a new |
| | | initialized object of class Section |
| | Create_New_Scorable_Mission | Create_New_Scorable_Mission |
| | | creates a new initialized object of |
| | | class Scorable_Mission. |
| | Create_New_Scored_Mission | Create_New_Scored_Mission creates |
| | | a new initialized object of class |
| | | Scored_Mission. This is preformed |
| | | when a Scorable_Mission is flown |
| | Update_User | Update_User modifies the values |
| | | stored in the User object. |
| | Update_Courses | Update_Courses modifies the values |
| | | stored in the Course object. |
| | Update_Sections | Update_Sections modifies the values |
| | | stored in the Section Object. |
| | Update_Scorable_Mission | Update_Scorable_Mission modifies |
| | | the values stored in the |
| | | Scorable_Mission Object |

| | |
|---|---|
| Interactions | DBMS interacts with all objects that have attributes. The DBMS |
| | is also responsible for linking Scorable_Missions to Courses and |
| | Sections, Sections to Grading_Instructors and Students, Scorable_Events |
| | to Scorable_Missions, and Scored_Missions to Scored_Events |
| | and the User that created the Scored_Mission. |

Use-case number-one (calculate score) preferably requires the following pre-conditions: 1) a scorable mission has been flown in MSFSX 211 (Microsoft Flight Simulator 10) that has scoring criteria and 2) student 205 is logged-in to aircraft electronic flight-mission simulation and scoring system 100, as shown. Use-case number-one preferably requires the post-condition that scorable mission 261 has been scored. Preferably use-case number-one scenario steps comprise: 1) MSFSX 211 signaling FS²X (Flight Simulator Scoring Extension) that the scorable mission has been flown; 2) FS²X getting the list of scorable events from DBMS; 3) FS²X getting the pass/fail status of events from FS²X stored while mission was flown; 4) FS²X adding the points for each event hit to obtain the actual raw-score; and 5) FS²X dividing the actual raw-score by the maximum raw-score to calculate the percentage score. Preferably FS²X then creates a record and stores the following information: user log in ID; course; section; mission number; mission name; date-time stamp; number of times flown; actual raw score; maximum raw score; percentage score; actual event score for each event; and possible event score for each event, as shown. Upon reading the teachings of this specification, those of ordinary skill in the art will understand that, under appropriate circumstances, considering such issues as new software packages, adoption of other simulation engines, incorporating the system disclosed herein into other simulation engines, such as, for example the Microsoft® ESP visual simulation platform, may suffice.

Referring again to FIG. 4 (and referencing FIGS. 5A, 5B, 5C), preferably use-case number-two (enter/modify scoring criteria for level A, level B or level C scoring) requires the following pre-conditions: 1) at least one scorable mission exists; and 2) course manager 209 has logged in, as shown. Use-case number-two preferably requires the post-condition that a set of mission scoring criteria has been successfully entered, as shown.

Preferably use-case number-two initial scenario steps comprise course manager 209 indicating that course manager 209 desires to enter scoring criteria for a course, followed by FS²X displaying a list of courses, followed by course manager 209 selecting a desired course for which to enter scoring criteria, as shown. Preferably subsequent steps of use-case number-two comprise FS²X displaying a list of missions that have been created in MSFSX 211 with the mission's currently being flown status, followed by an informational message informing course manager 209 that the current scoring criteria is no longer valid and needs to be updated (if mission file has been modified, as shown), followed by course manager 209 identifying the mission for which scoring criteria is to be applied, and FS²X marking the selected mission status as not flyable, as shown. Preferably the still further subsequent use-case number-two steps comprise FS²X asking course manager 209 to provide a default “per event” score, followed by course manager 209 entering the default “per event” score, followed by FS²X displaying a list of all MSFSX Event IDs, their corresponding descriptions and the possible event score, as shown. Preferably the then additional subsequent steps use-case number two comprise course manager 209 selecting a scorable event, as shown, to edit the score of the scorable event; followed by FS²X giving an editable field in which to change the score of the scorable event, followed by course manager 209 changing the score on the scorable event, followed by repeating the change of the score of the scorable event until course manager 209 is satisfied, as shown. Preferably the still additional subsequent steps of use-case number two comprise course manager 209 optioning to make the mission flyable by grading instructor 208, followed by course manager 209 indicating that course manager 209 is finished, followed by FS²X setting the mission flyable by grading instructors, as shown, and saving the mission scoring criteria, as shown.

Referring again to FIG. 4 (and referencing FIGS. 5A, 5B, and 5C), preferably use-case number-three (view score) requires the pre-condition that user 202 is logged in, as shown. Use-case number-three preferably requires no specific post-conditions. Preferably use-case number-two initial scenario steps comprise user 202 indicating that user 202 wants to view scores, as shown, followed by FS²X displaying a list of scored missions (containing the mission name, date scored, log in ID, course, section and actual raw score/maximum possible raw score), as shown, followed by FS²X displaying the list of scored missions for user 202, as shown (at least embodying herein the step of providing for at least one score viewer such that such at least one user can view such multiple quantitative scoring levels of each of such plurality of scorable events along such at least one simulated flight mission to provide at least one scorable mission, adapted to allow such at least one user to only view such plurality of scorable events along such at least one simulated flight mission during said at least one scorable mission).

Alternately preferably, use-case number-two initial scenario step comprises FS²X displaying the list of scored missions flown by students in class sections for which grading instructor 208 is responsible when grading instructor 208 indicates that grading instructor 208 wants to view Level B or Level C scores. Grading instructor 208 then may preferably select the scored mission 235 that grading instructor 208 desires to view, followed by FS²X displaying the score details of scored mission 235 (at least embodying herein the step of providing for at least one score viewer such that such at least one user can view such multiple quantitative scoring levels of each of such plurality of scorable events along such at least one simulated flight mission to provide at least one scorable mission, adapted to allow such at least one user to only view such plurality of scorable events along such at least one simulated flight mission, only after the completion of said at least one scorable mission).

Preferably, as shown, FS²X then creates a record and stores the following information: user 202 log in ID; course; section; mission number; mission name; date-time stamp; number of times flown; actual raw score; maximum raw score; percentage score; actual event score for each event, as shown; and possible event score for each event, as shown.

Referring again to FIG. 4 (and referencing FIGS. 5A, 5B, and 5C), preferably use-case number-four (create/modify courses) requires the pre-condition that course manager 209 has completed the course manager authorized login procedure, as shown. Use-case number-four preferably requires the post-conditions of: 1) at least one new course created; or 2) at least one existing course updated, as shown. Preferably use-case number-four scenario steps comprise course manager 209 indicating that course manager 209 wants to create or modify courses. Subsequently, FS²X preferably displays to course manager 209 a list of current courses with an option to add at least one new course. Course manager 209 preferably informs FS²X which course (including at least one new course) that course manager 209 wants to create or modify. Subsequently, FS²X preferably displays all related sections to the course, as shown, with an option to add a new section. Course manager 209 may now inform FS²X which section course manager 209 would like to create or modify. Preferably additionally subsequent steps of use-case number-four comprise FS²X returning course manager 209 to the list of sections and course manager 209 then repeating the prior sequence of use-case number-four steps until course manager 209 informs FS²X course manager 209 has completed creating or modifying the selected at least one course. Additional preferable subsequent steps of use-case number-four comprise FS²X returning course manager 209 to a list of courses, as showed, and the course manager 209 repeating the prior sequence of use-case number-four steps until course manager 209 informs FS²X that course manager 209 is done with the selected modifying/creating courses. Additionally preferably, if the section is a new section course, subsequent steps of use-case number-four comprise FS²X prompting manager 209 to enter all required information about the section comprising section number, term, and grading instructor 208 that will be reviewing/evaluating the section. Preferably thereafter FS²X creates a record and stores all required information about section 215, as shown, comprising section number, term, and grading instructor 208 that will be reviewing/evaluating section 215.

Referring again to FIG. 4 (and referencing FIGS. 5A, 5B, and 5C), preferably use-case number-five (enter/modify grading instructor) requires the pre-condition of course manager 209 authorized login, as shown. Use-case number-five preferably requires the post-condition grading instructor created or modified, as shown. Preferably use-case number-five scenario steps comprise: course manager 209 indicating to FS²X that course manager 209 wants to enter/modify grading instructor 208, followed by FS²X displaying a list available grading instructors 208, preferably with an option to add at least one additional grading instructor 208. Additional preferable subsequent steps of use-case number-five comprise course manager 209 selecting grading instructor 208 to be modified, or if grading instructor 208 is a new entry—FS²X prompts course manager 209 to enter required information about grading instructor 208, as shown. Required information about grading instructor 208 comprises Log_in_id and Log_in_password. Preferably additionally subsequent steps of use-case number-five comprise course manager 209 informing FS²X course manager 209 has completed modifying grading instructor 208, followed by FS²X returning to course manager 209 a list of grading instructors 208, followed by course manager 209 repeating the above subsequent steps of use-case number-five until course manager 209 informs FS²X that course manager 209 has completed entering/modifying grading instructors 208. Preferably FS²X then creates a record and stores all entering/modifying grading instructors 208 information.

Referring again to FIG. 4 (and referencing FIGS. 5A, 5B, and 5C), preferably use-case number-six (enter/modify students) requires the pre-conditions that 1) grading instructor 208 is logged into the system and 2) grading instructor 208 is assigned to at least one section. Use-case number-six preferably requires the post-condition that at least one new student 205 (or user 202 or remote user 206) has been created, as shown. Preferably use-case number-five scenario steps comprise: grading instructor 208 indicating to FS²X that grading instructor 208 would like to enter/modify students 205. Subsequently, FS²X presents to grading instructor 208 a display window, as shown, of at least one section 215 that grading instructor 208 is assigned to in FS²X. Next, grading instructor 208 preferably informs FS²X of at least one section 215 that grading instructor 208 desires to update. Preferably additionally subsequent steps of use-case number-six comprise FS²X displaying at least one student 205 to at least one section 215 with at least one option to add at least one new student. Grading instructor 208 preferably informs FS²X which student that grading instructor 208 desires to modify. FS²X then displays user information, as shown, for at least one student 205 with at least one option to modify user information of at least one student 205. Still additional preferable subsequent steps comprise grading instructor 208 informing FS²X that grading instructor 208 has completed modifying user information, followed by FS²X returning grading instructor 208 to section 215, where grading instructor 208 may repeat the above use-case number-six steps until grading instructor 208 informs FS²X that grading instructor 208 has completed entering and modifying user information of at least one student 205. Preferably FS²X then creates a record and stores all entering/modifying. Preferably FS²X then creates a record and stores new and modified user information of at least one student 205.

Referring again to FIG. 4 (and referencing FIGS. 5A, 5B, and 5C), preferably use-case number-seven (display welcome window) requires the following pre-conditions: 1) FS²X and MSFSX 211 are installed on at least one computer of at least one student 205; and 2) at least one computer of at least one student 205 has access to DBMS 220 through HMI manager 104, as shown. Use-case number-seven preferably requires the following post-conditions: 1) FS²X displaying a welcome window with a list of available use-cases comprising at least on course 210, at least one section 215, at least one MSFSX 211 mission 250, at least one scorable mission 240, or at least one HMI user; and 2) FS²X knowing the type of user 202 currently interacting with FS²X, as defined by HMI user, as shown. Preferably use-case number-seven scenario steps comprise: user 202 initiating FS²X through HMI manager 104, followed by FS²X displaying at least one welcome window, as shown, comprising user login Id request and password request followed by user submission of a login and password to FS²X. Preferably additionally subsequent steps of use-case number-seven comprise FS²X checking user 202 entered login and password against DBMS records, followed by repeating this sequence until user 202 enters a valid user login and password (as determined by FS²X against DBMS records). Still additional preferable subsequent steps comprise FS²X displaying at least one available action, for user 202, of the following available actions: flying a scorable mission and viewing a score. More additional preferable subsequent steps comprise FS²X displaying at least one available action for, a course manager, of the following available actions: entering scoring criteria, entering/modifying courses, entering/modifying grading instructors, entering/modifying students, viewing at least one score, flying at least one scorable mission, and setting at least one mission flyable by student 205. Still more additional preferable subsequent steps comprise FS²X displaying at least one available action for, at least one grading instructor 208, of the following available actions: entering/modifying student 205, viewing at least one score, flying at least one scorable mission, and setting at least one mission flyable by student 205. Preferably FS²X then creates at least one record and any stores new or modified user information, course manager information, and grading instructor information.

Referring again to FIG. 4 (and referencing FIGS. 5A, 5B, and 5C), preferably use-case number-eight (fly scorable mission) requires the following pre-conditions: 1) FS²X and MSFSX 211 are installed on a computer of user 202; and 2) user 202 is logged in. Use-case number-seven preferably requires the post-conditions that FS²X starts MSFSX 211 with appropriate scorable missions 240 for user 202. Preferably use-case number-seven scenario steps comprise: user 202 selecting an option to fly at least one scorable mission 240, FS²X informing MSFSX 211 of the mission that user 202 is currently able to fly, FS²X starting MSFSX 211 with only the scorable mission 240 that is flyable by user 202, FS²X informing MSFSX 211 to report when at least one user 202 is starting and ending scorable mission 240, and FS²X listening for event scoring gradation and associated pass/fail criteria signals of scorable event 230 from MSFSX 211.

Referring again to FIG. 4 (and referencing FIGS. 5A, 5B, and 5C), preferably use-case number-nine (display welcome window) requires the pre-conditions of: 1) at least one scorable mission exists in FS²X; and 2) at least one course manager 204A is logged in, as shown. Use-case number-nine preferably requires the post-conditions of: 1) at least one scorable mission 240 is flyable by at least one student 202, as shown. Preferably use-case number-nine scenario steps comprise: at least one course manager indicating that the course manager wants to set a mission flyable by at least one user 202, followed by FS²X displaying a list of sections that at least one user 202 has privileges to update, as shown, and including course name and course number (as shown in course 210) and additionally section number and section term as shown in section 215. Preferably additionally subsequent steps of use-case number-nine comprise at least one course manager selecting which section 215 that course manager wishes to modify. In response to a section selection, FS²X preferably displays at least one scorable mission 240 for the selected section wherein the at least one scorable mission 240 displays the mission name of scorable mission 240, displays the mission status (if the mission is being/has been flown), and allows the course manager to select a particular mission name of a scorable mission that the course manager wishes that user 202 (a student, mission performer, etc.) fly.

FIGS. 5A, 5B, and 5C together show a preferred domain object model, according to the preferred embodiment of the present invention. DBMS 220 interacts with all objects that have attributes. DBMS 220 is also links scorable mission 240 to courses 210 and sections 215, sections 215 to grading instructors 203A and students 202A, scorable events 230 to scorable missions 240, and scored missions 240 to scored events 230 and to user 202 that created the scored mission 235.

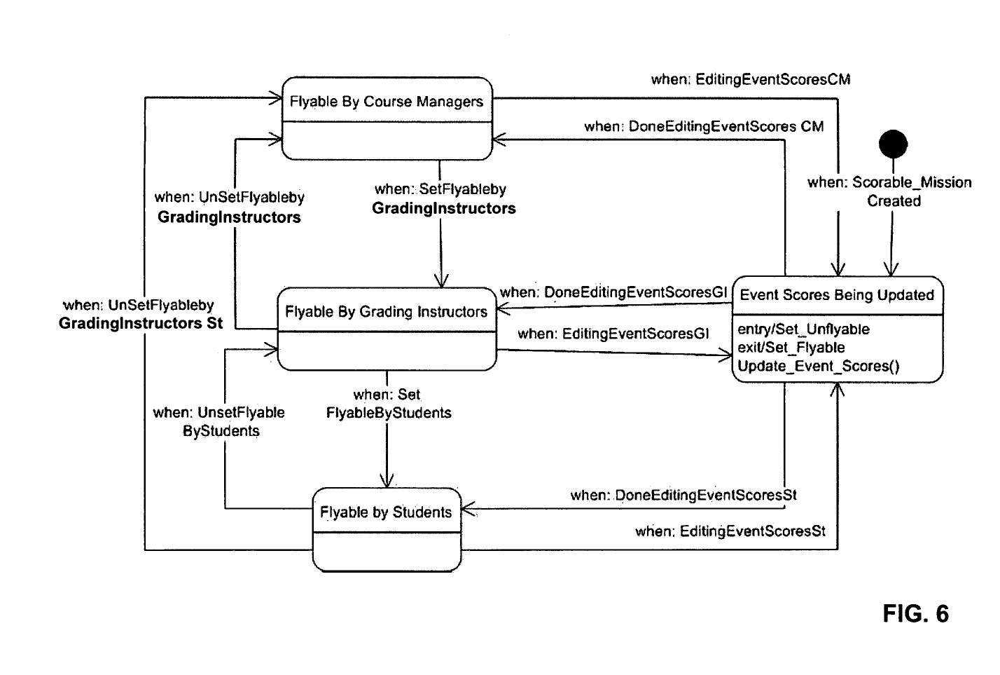

FIG. 6 shows a schematic view, illustrating a preferred object state diagram, according to the preferred embodiment of the present invention.

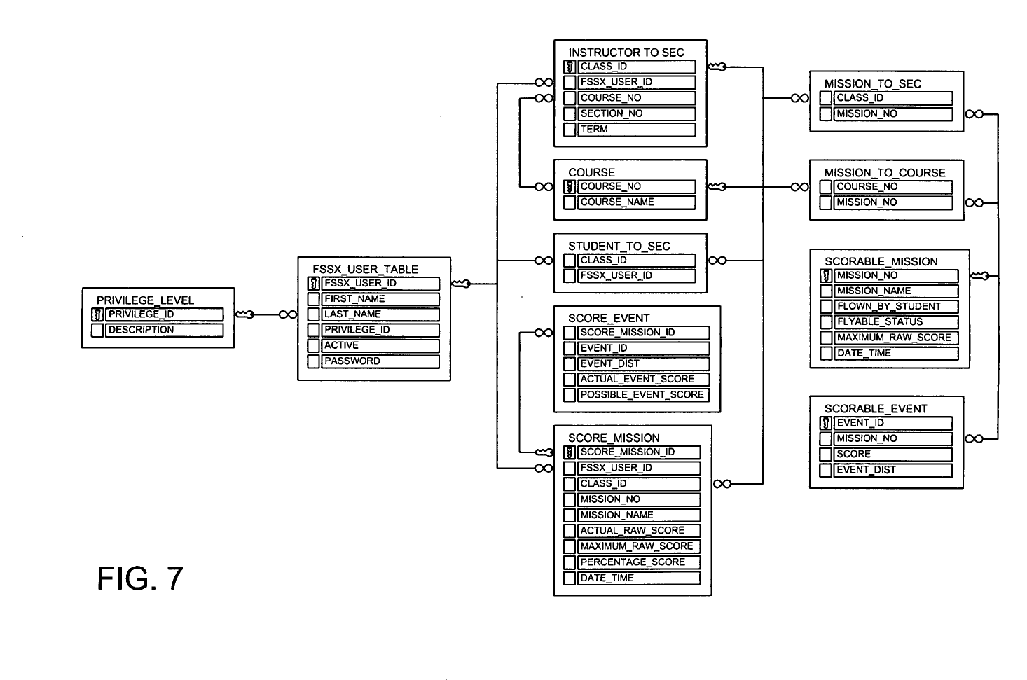

FIG. 7 shows a schematic view, illustrating a preferred database structural design, according to the preferred embodiment of the present invention. FS²X user table contains user information comprising: user id, first name, last name, privilege level, active or non-active, and users' password, as shown. Users preferably comprise course manager, grading instructor, and student. Users are determined by their privilege level within preferred aircraft electronic flight-mission simulation and scoring system 100. A course manager may preferably assign a particular grading instructor to a particular section in a particular course as long as the particular grading instructor to be assigned to a course exists in the FS²X user-table and the to-be-assigned course is in an FS²X course table, as shown. Course manager may preferably assign a score to as many events as a scorable mission has, each score being a composite of at least two measurements. Two highly preferred aspects present in scorable-mission table (see FIG. 7) are “flyable status” and “flown by student” table elements. If a course manager marks the FS²X “flyable status feature” on a scored mission as “not flyable”, then a grading instructor will be unable to see (and unable to assign) the scorable mission. If a course manager marks scorable mission as “not flown by student”, then the course manager is prevented and locked out from making changes to a scored event on at least one associated scorable mission. Once a course manager assigns at least one grading instructor a section in a course, the grading instructor may assign same to a student belonging to the section (as long as the student exists in the FS²X user table). When a course manager marks a scorable mission as “flyable”, and a grading instructor gives permission to a student to view the “flyable” mission, then the student may view and fly the scorable mission. After the student has flown the scorable mission, the actual raw score and calculated score are saved in the score_mission table shown in FIG. 7 along with student ID. An event score for each mission is also preferably stored in the score_event table shown in FIG. 7 along with a mission number.

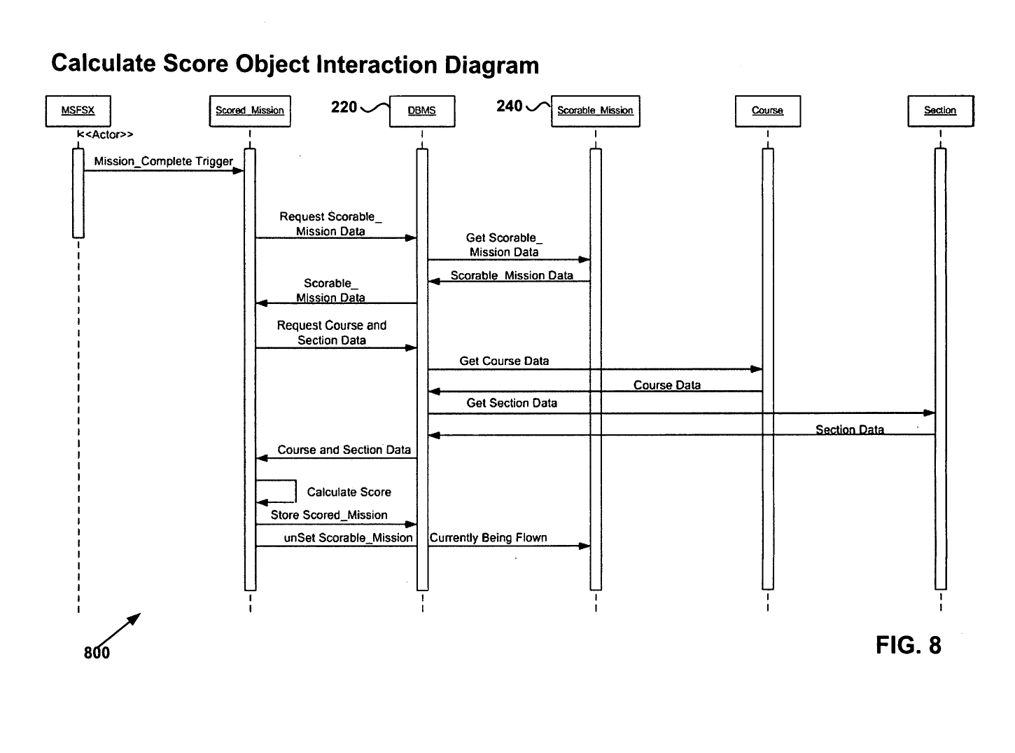

FIG. 8 shows a schematic view, illustrating a preferred object interaction diagram for calculating a score of a scorable mission, according to the preferred embodiment of the present invention. The “calculate score” object-interaction-diagram portrays preferred communication links and preferred flows of data between and among defined programmatic objects, for preferred aircraft electronic flight-mission simulation and scoring system 100. FIG. 8 shows preferred object interactions during the use-case number-one (calculate score). Refer to FIG. 4 for related use-case information, FIG. 5 for related domain object model information, FIG. 6 for related object state diagram, and FIG. 7 for related database structure.

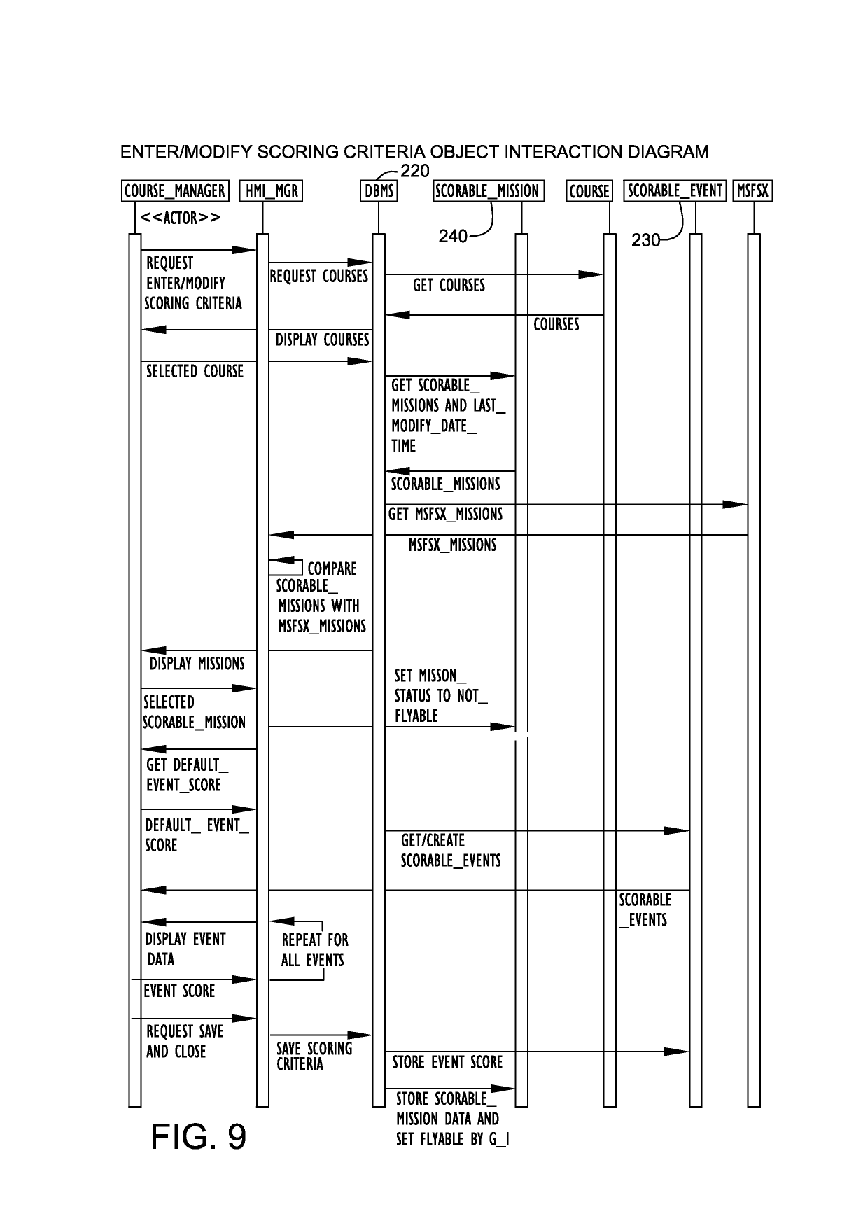

FIG. 9 shows a schematic view, illustrating a preferred object interaction diagram for entering and modifying a score of a scorable mission, according to the preferred embodiment of the present invention. The “entering and modifying a score of a scorable mission” object-interaction-diagram portrays preferred communication links and preferred flows of data between and among defined programmatic objects, for preferred aircraft electronic flight-mission simulation and scoring system 100. FIG. 8 shows preferred object interactions during the use-case number-two (entering and modifying a score of a scorable mission). Refer to FIG. 4 for related use-case information, FIG. 5 for related domain object model information, FIG. 6 for related object state diagram, and FIG. 7 for related database structure.

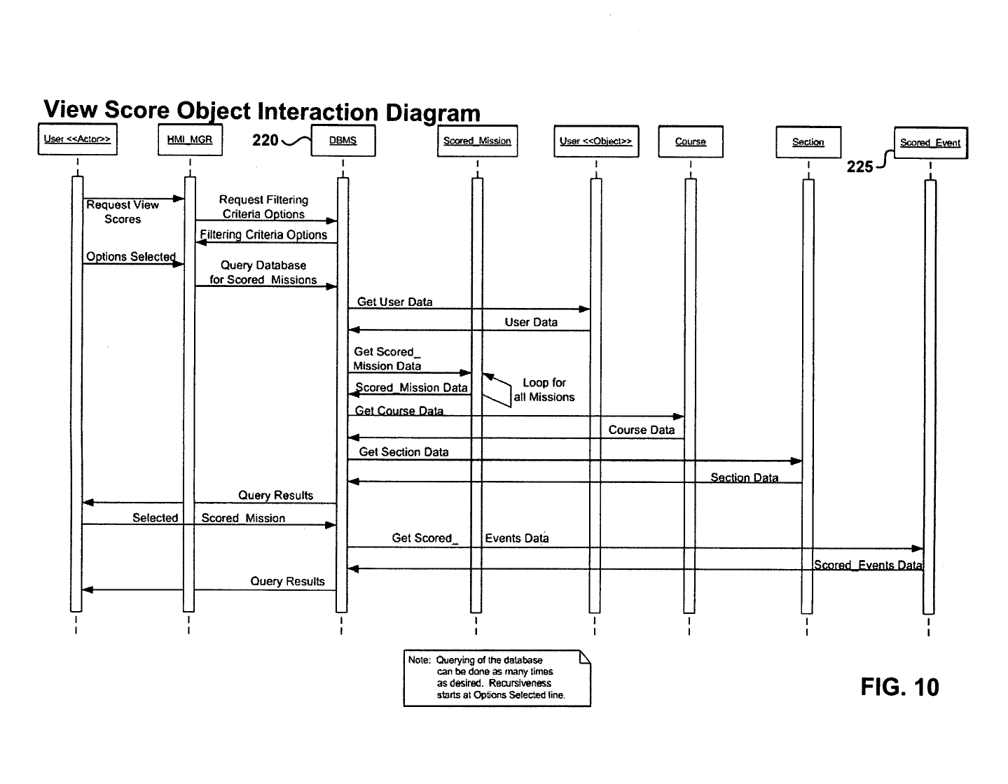

FIG. 10 shows a schematic view, illustrating a preferred object interaction diagram for view a score, according to the preferred embodiment of the present invention. The “view a score” object-interaction-diagram portrays preferred communication links and preferred flows of data between and among defined programmatic objects, for preferred aircraft electronic flight-mission simulation and scoring system 100. FIG. 8 shows preferred object interactions during the use-case number-three (view a score). Refer to FIG. 4 for related use-case information, FIG. 5 for related domain object model information, FIG. 6 for related object state diagram, and FIG. 7 for related database structure.

FIG. 11 shows a schematic view, illustrating a preferred object interaction diagram for entering and modifying a course of at least one scorable mission, according to the preferred embodiment of the present invention. The “Entering and modifying a course of at least one scorable mission” object-interaction-diagram portrays preferred communication links and preferred flows of data between and among defined programmatic objects, for preferred aircraft electronic flight-mission simulation and scoring system 100. FIG. 8 shows preferred object interactions during the use-case number-four (entering and modifying a course of at least one scorable mission). Refer to FIG. 4 for related use-case information, FIG. 5 for related domain object model information, FIG. 6 for related object state diagram, and FIG. 7 for related database structure.

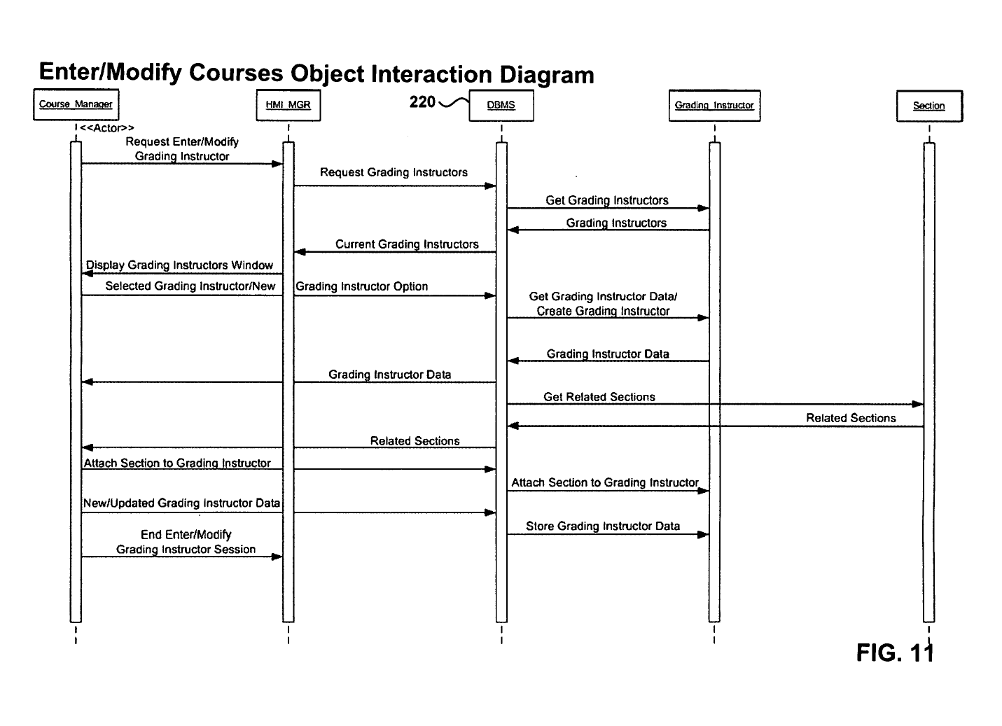

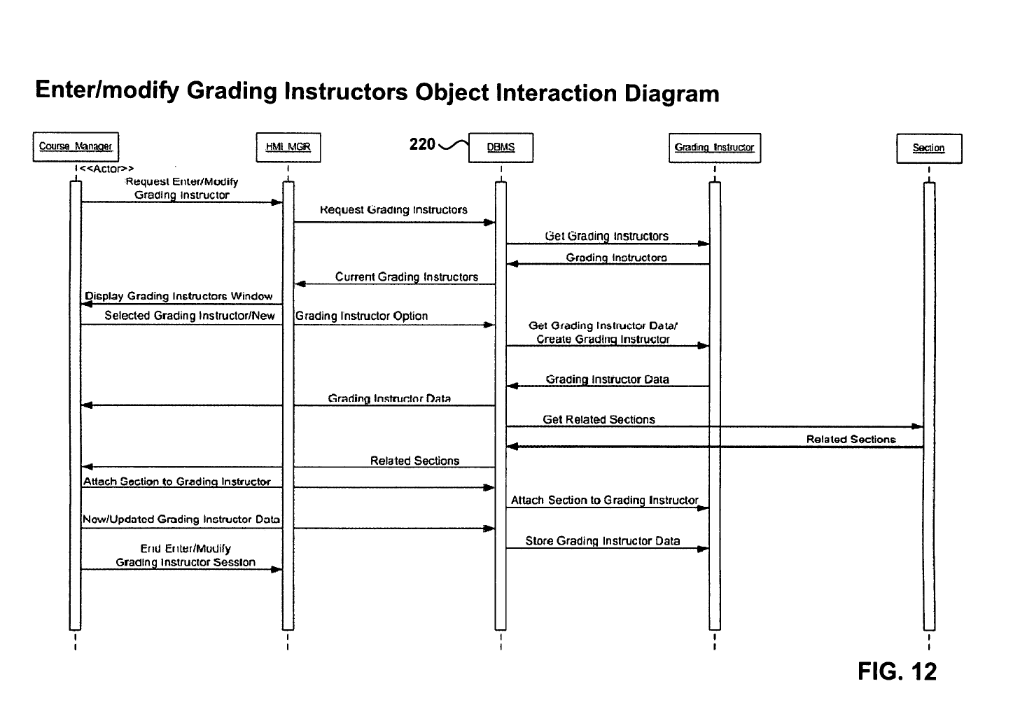

FIG. 12 shows a schematic view, illustrating a preferred object interaction diagram for entering and modifying at least one course grade of at least one scorable mission by at least one grading instructor, according to the preferred embodiment of the present invention. The “Entering and modifying at least one course grade of at least one scorable mission by at least one grading instructor” object-interaction-diagram portrays preferred communication links and preferred flows of data between and among defined programmatic objects, for preferred aircraft electronic flight-mission simulation and scoring system 100. FIG. 8 shows preferred object interactions during the use-case number-five (entering and modifying at least one course grade of at least one scorable mission by at least one grading instructor). Refer to FIG. 4 for related use-case information, FIG. 5 for related domain object model information, FIG. 6 for related object state diagram, and FIG. 7 for related database structure.

FIG. 13 shows a schematic view, illustrating a preferred object interaction diagram for entering and modifying at least one student for at least one course grade of at least one scorable mission by at least one grading instructor, according to the preferred embodiment of the present invention. The “Entering and modifying at least one student for at least one course grade of at least one scorable mission by at least one grading instructor” object-interaction-diagram portrays preferred communication links and preferred flows of data between and among defined programmatic objects, for preferred aircraft electronic flight-mission simulation and scoring system 100. FIG. 8 shows preferred object interactions during the use-case number-six (entering and modifying at least one student for at least one course grade of at least one scorable mission by at least one grading instructor). Refer to FIG. 4 for related use-case information, FIG. 5 for related domain object model information, FIG. 6 for related object state diagram, and FIG. 7 for related database structure.

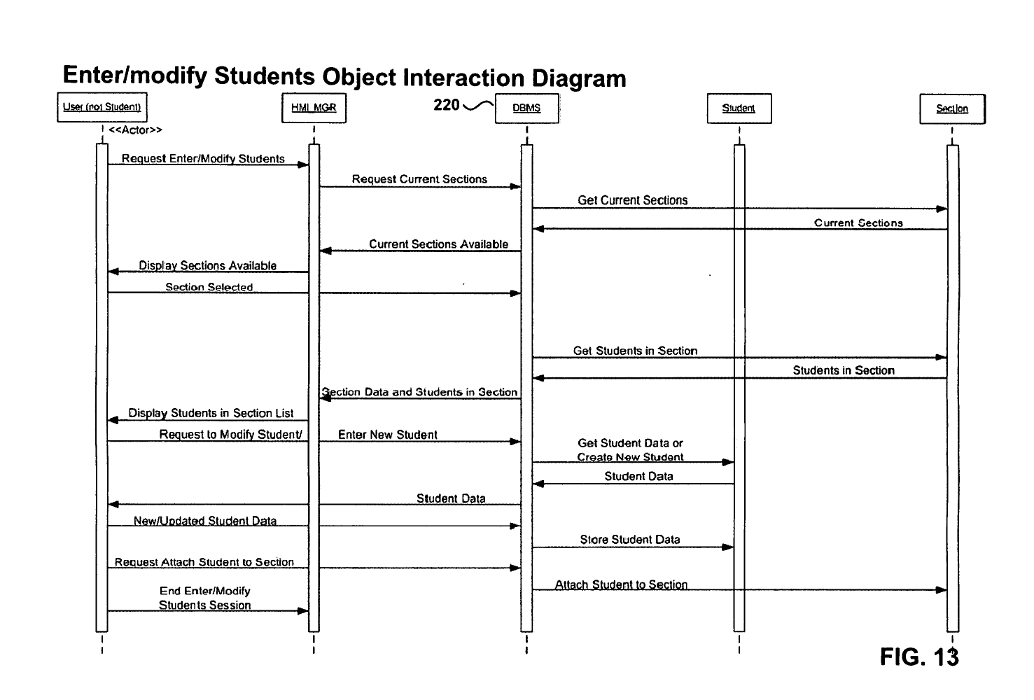

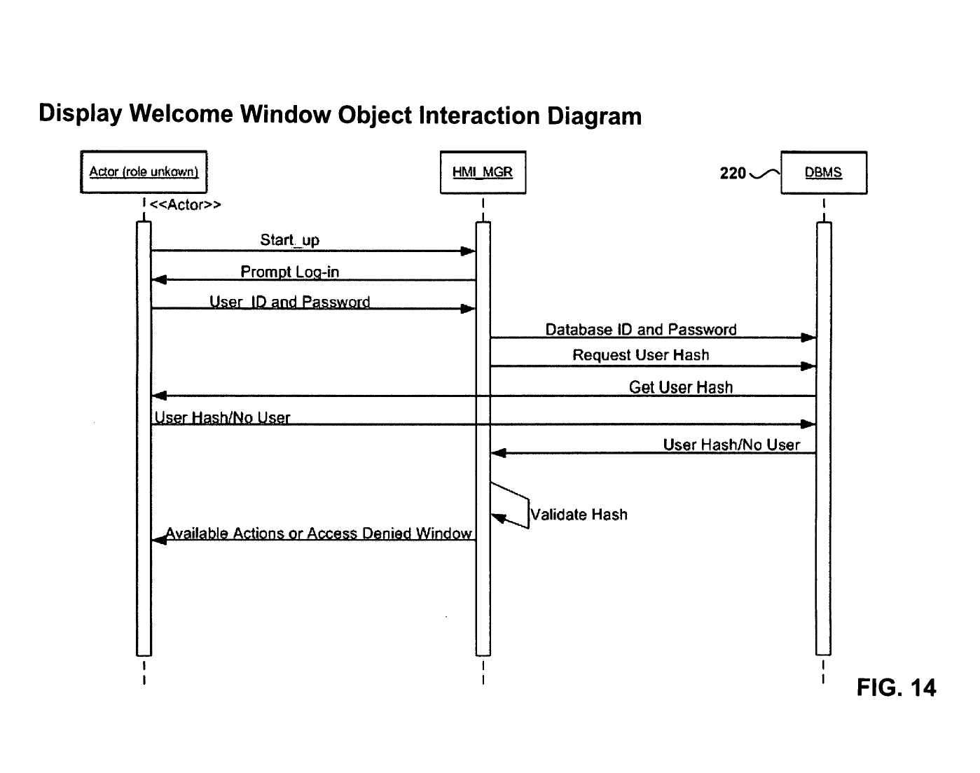

FIG. 14 shows a schematic view, illustrating a preferred object interaction diagram for displaying at least one welcome window for at least one scorable mission, according to the preferred embodiment of the present invention. The “Displaying at least one welcome window for at least one scorable mission” object-interaction-diagram portrays preferred communication links and preferred flows of data between and among defined programmatic objects, for preferred aircraft electronic flight-mission simulation and scoring system 100. FIG. 8 shows preferred object interactions during the use-case number-seven (displaying at least one welcome window for at least one scorable mission). Refer to FIG. 4 for related use-case information, FIG. 5 for related domain object model information, FIG. 6 for related object state diagram, and FIG. 7 for related database structure.

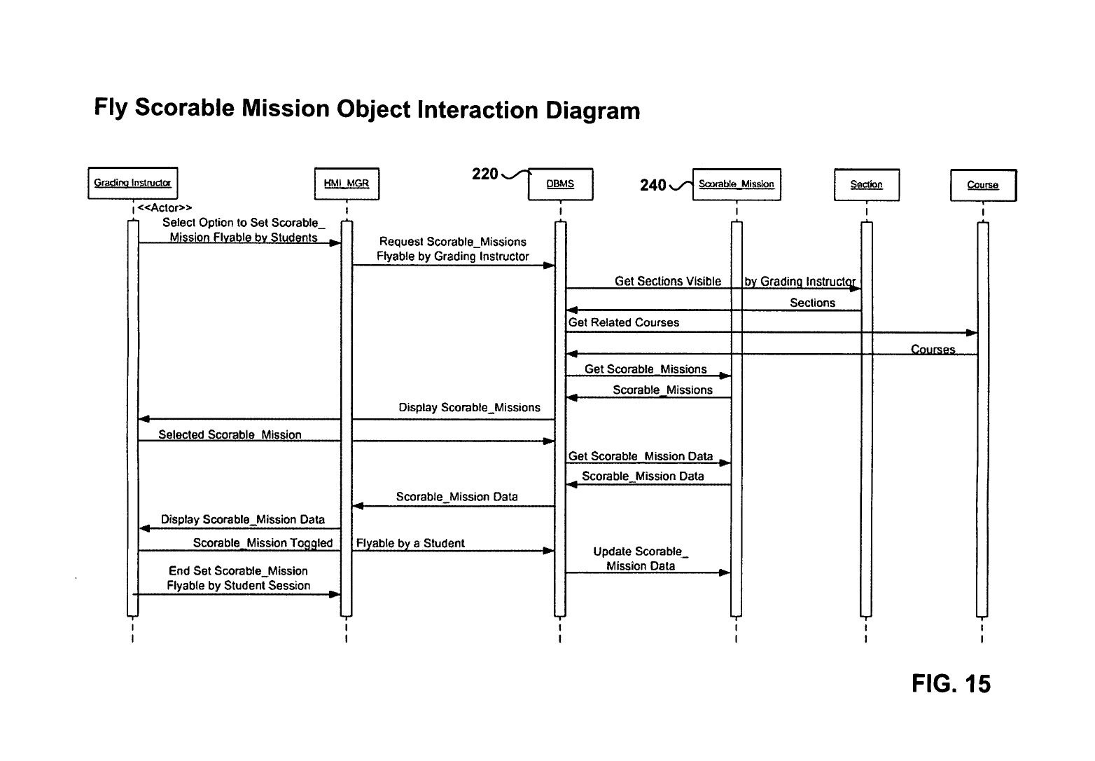

FIG. 15 shows a schematic view, illustrating a preferred object interaction diagram for flying at least one scorable mission, according to the preferred embodiment of the present invention. The “Flying at least one scorable mission” object-interaction-diagram portrays preferred communication links and preferred flows of data between and among defined programmatic objects, for preferred aircraft electronic flight-mission simulation and scoring system 100. FIG. 8 shows preferred object interactions during the use-case number-eight (flying at least one scorable mission). Refer to FIG. 4 for related use-case information, FIG. 5 for related domain object model information, FIG. 6 for related object state diagram, and FIG. 7 for related database structure.

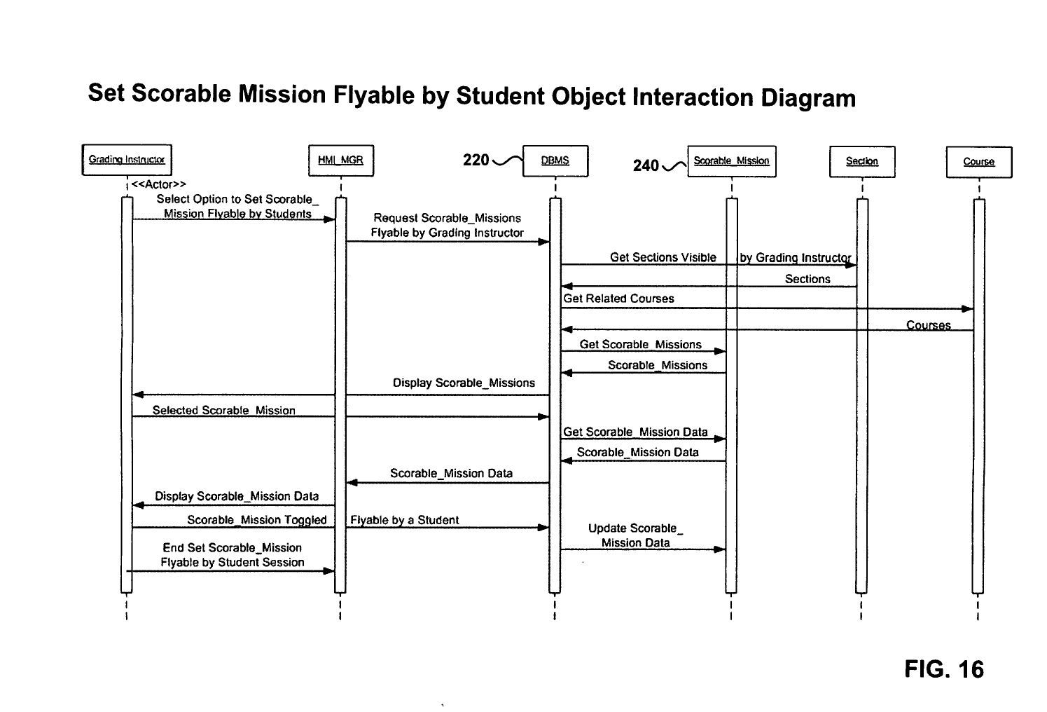

FIG. 16 shows a schematic view, illustrating a preferred object interaction diagram for setting at least one scorable mission for at least one student, according to the preferred embodiment of the present invention. The “Setting at least one scorable mission for at least one student” object-interaction-diagram portrays preferred communication links and preferred flows of data between and among defined programmatic objects, for preferred aircraft electronic flight-mission simulation and scoring system 100. FIG. 8 shows preferred object interactions during the use-case number-nine (setting at least one scorable mission for at least one student). Refer to FIG. 4 for related use-case information, FIG. 5 for related domain object model information, FIG. 6 for related object state diagram, and FIG. 7 for related database structure.

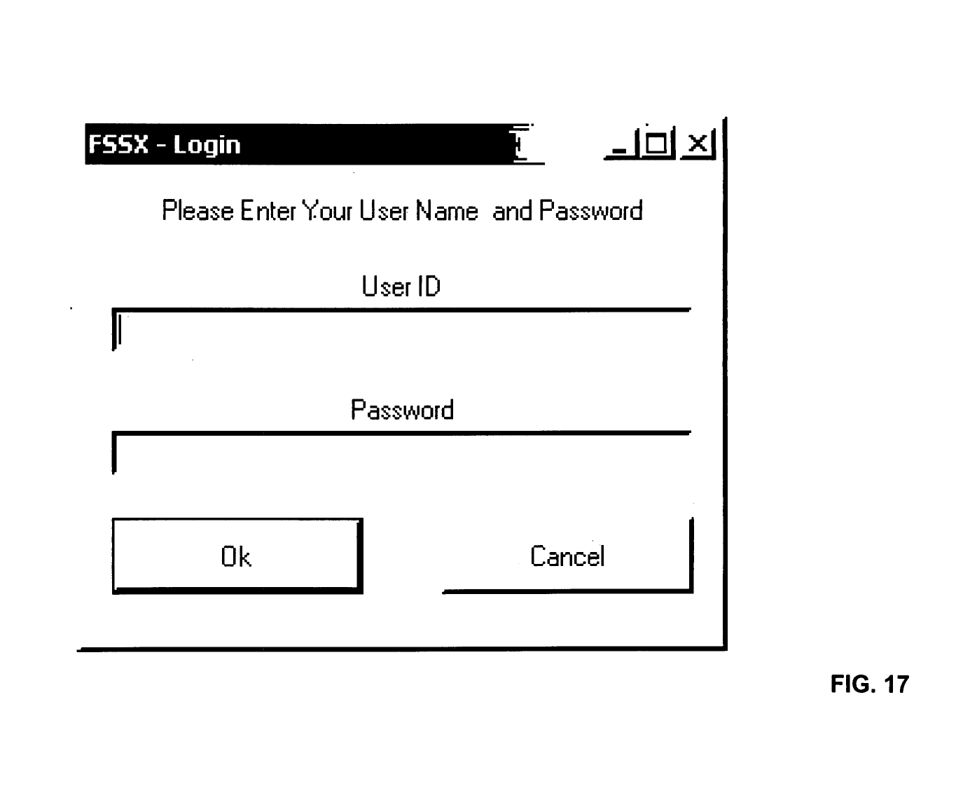

FIG. 17 shows a front view, illustrating a preferred login screen for at least one user 202 of at least one scorable mission 240, according to the preferred embodiment of the present invention. FIG. 17 shows an interface window in which user 202 preferably enters the user ID and password portions of user-required database information into aircraft electronic flight-mission simulation and scoring system 100.

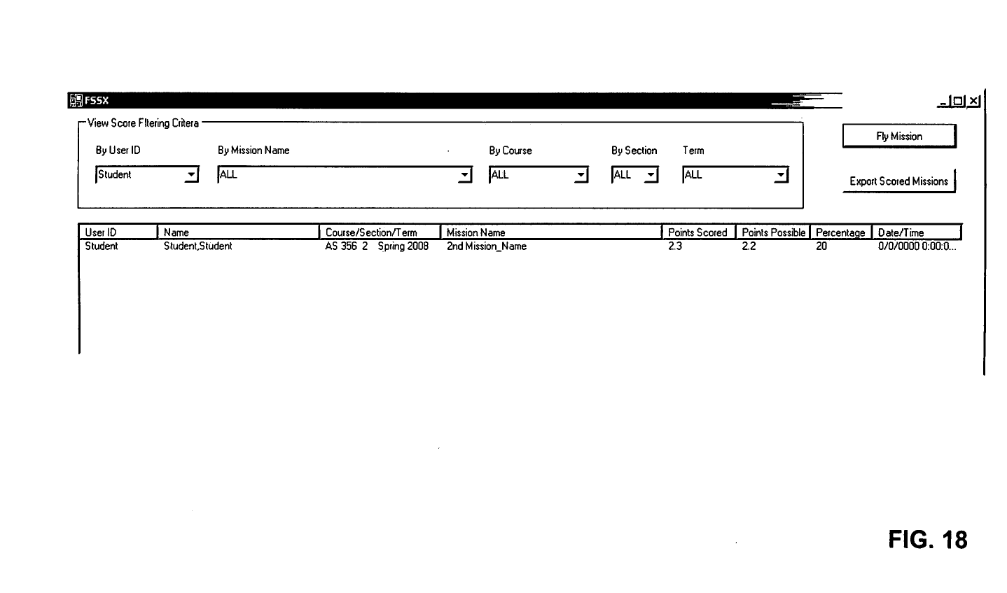

FIG. 18 shows a front view, illustrating a preferred viewing screen for viewing at least one score filtering criterion for at least one student 205, according to the preferred embodiment of the present invention. FIG. 18 shows a basic interface window for course manager 209 to enter the user ID, mission name, course, section and term required database information into aircraft electronic flight-mission simulation and scoring system 100.

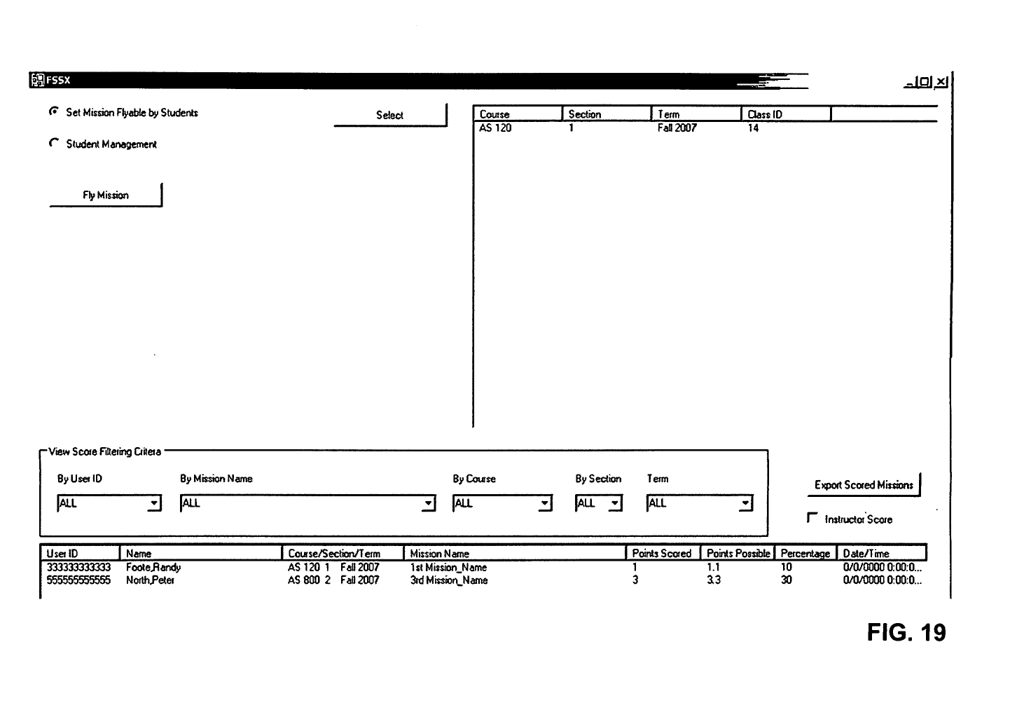

FIG. 19 shows a front view, illustrating a preferred managing screen for managing at least one student management criterion for at least one student 205 by at least one grading instructor 208, according to the preferred embodiment of the present invention. FIG. 19 shows a basic interface window for course manager 209 to enter the set flyable mission, and view score filtering criteria required database information into aircraft electronic flight-mission simulation and scoring system 100.

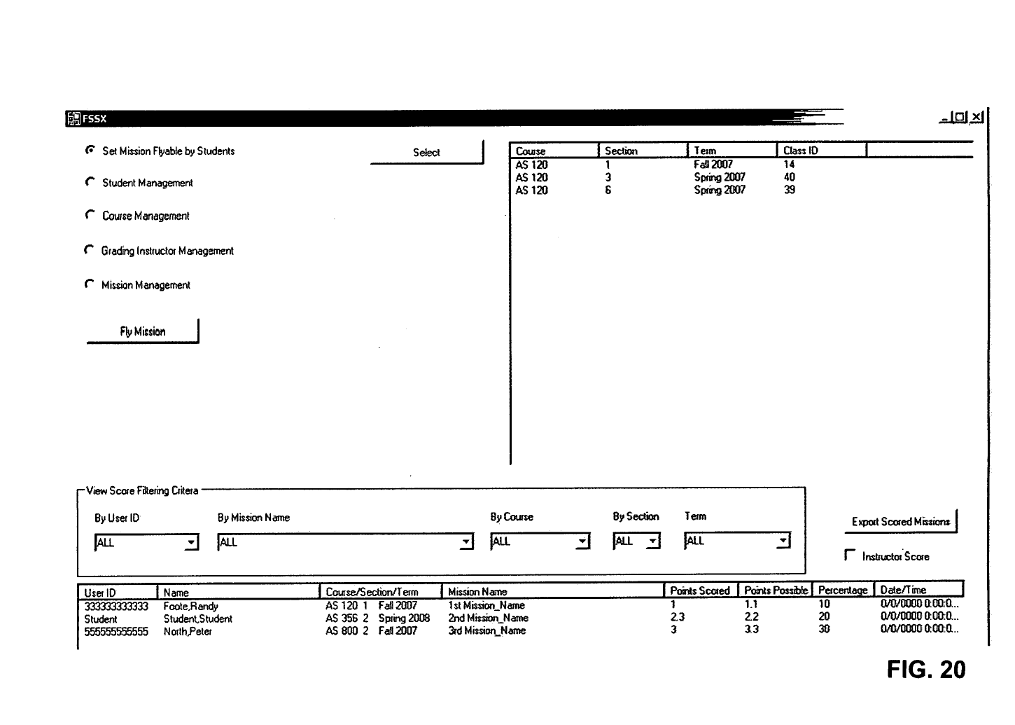

FIG. 20 shows a front view, illustrating a preferred managing screen for managing at least one student course criterion for at least one student course by at least one course manager 209, according to the preferred embodiment of the present invention. FIG. 20 shows a basic interface window for course manager 209 to enter the user ID, course, section and term and related mission flyable-by-students required database information into aircraft electronic flight-mission simulation and scoring system 100.

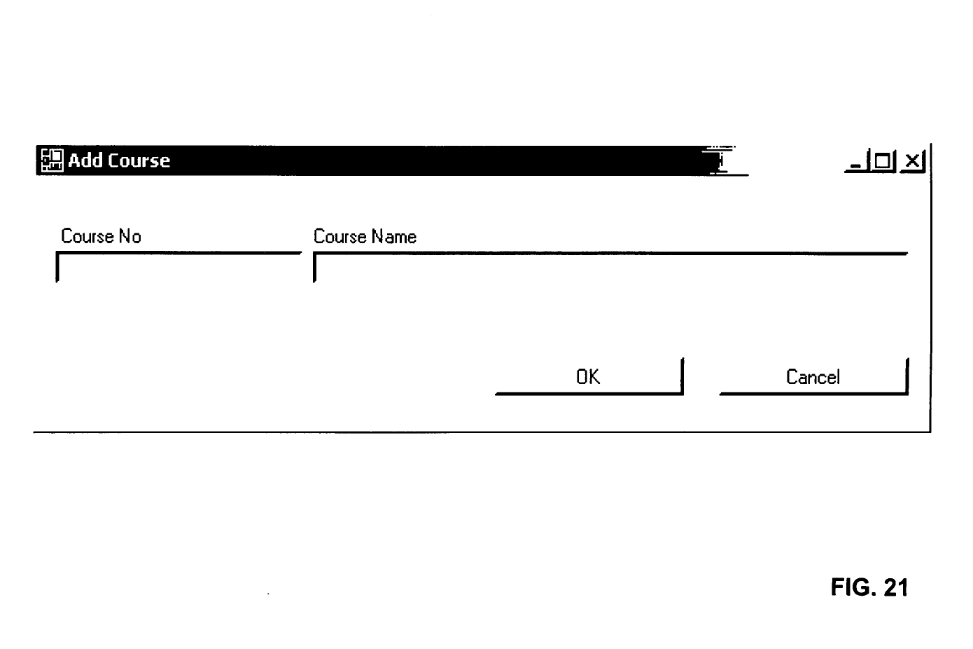

FIG. 21 shows a front view, illustrating a preferred interactive screen for adding at least one course for at least one student 205 by at least one course manager 209, according to the preferred embodiment of the present invention. FIG. 21 shows a basic interface window for course manager 209 to enter the user ID database information required to add a course into aircraft electronic flight-mission simulation and scoring system 100.

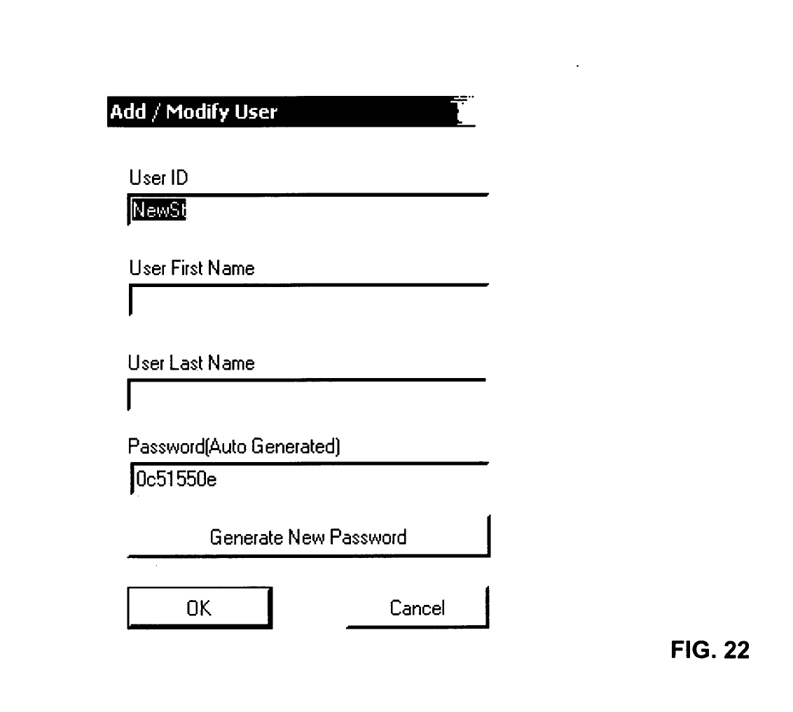

FIG. 22 shows a front view, illustrating a preferred interactive screen for adding and modifying at least one student credential for at least one student 205 by at least one course manager 209, according to the preferred embodiment of the present invention. FIG. 22 shows a basic interface window for course manager 209 to enter the database information required to add or modify user 202 into aircraft electronic flight-mission simulation and scoring system 100.

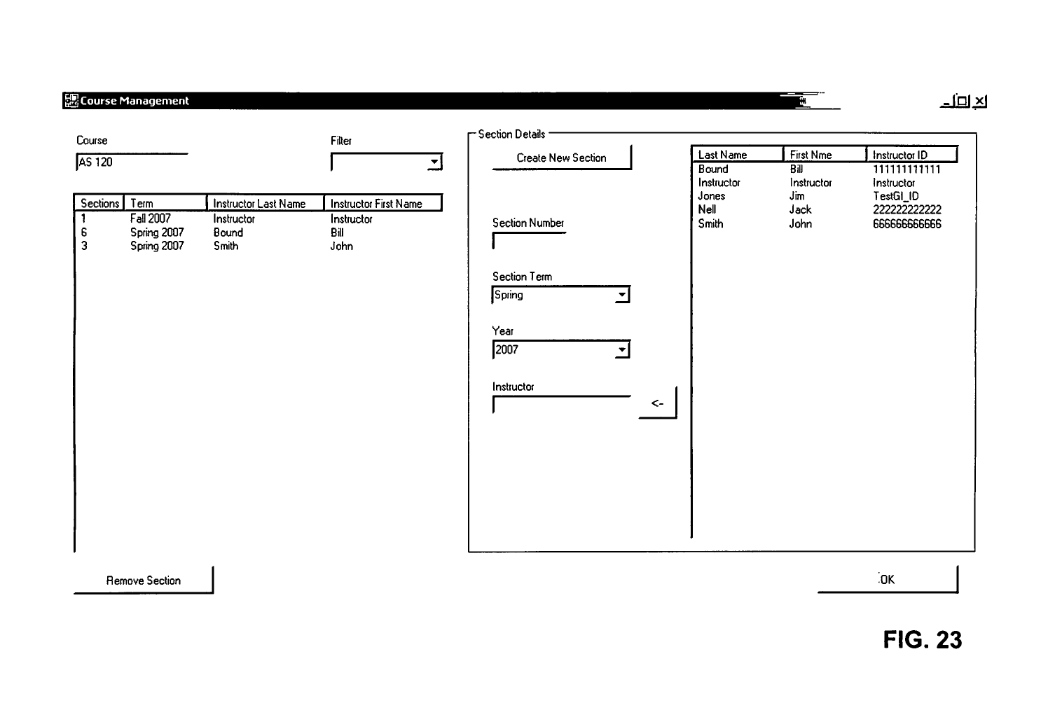

FIG. 23 shows a front view, illustrating a preferred managing screen for managing at least one course for at least one student 205 by at least one course manager 209, according to the preferred embodiment of the present invention. FIG. 23 shows a basic interface window for course manager 209 to enter the database information required to manage a course, comprising section, term and instructor into aircraft electronic flight-mission simulation and scoring system 100, as shown.

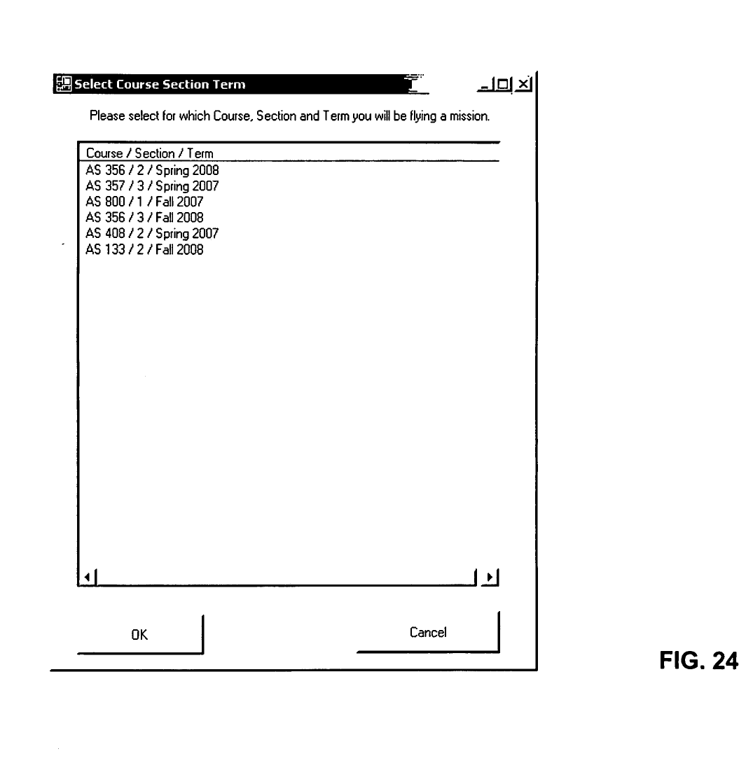

FIG. 24 shows a front view, illustrating a preferred selecting screen for selecting at least one course term for at least one student 205 by at least one course manager 209, according to the preferred embodiment of the present invention. FIG. 24 shows a basic interface window for course manager 209 to enter the database information required to select a course and related term into aircraft electronic flight-mission simulation and scoring system 100.

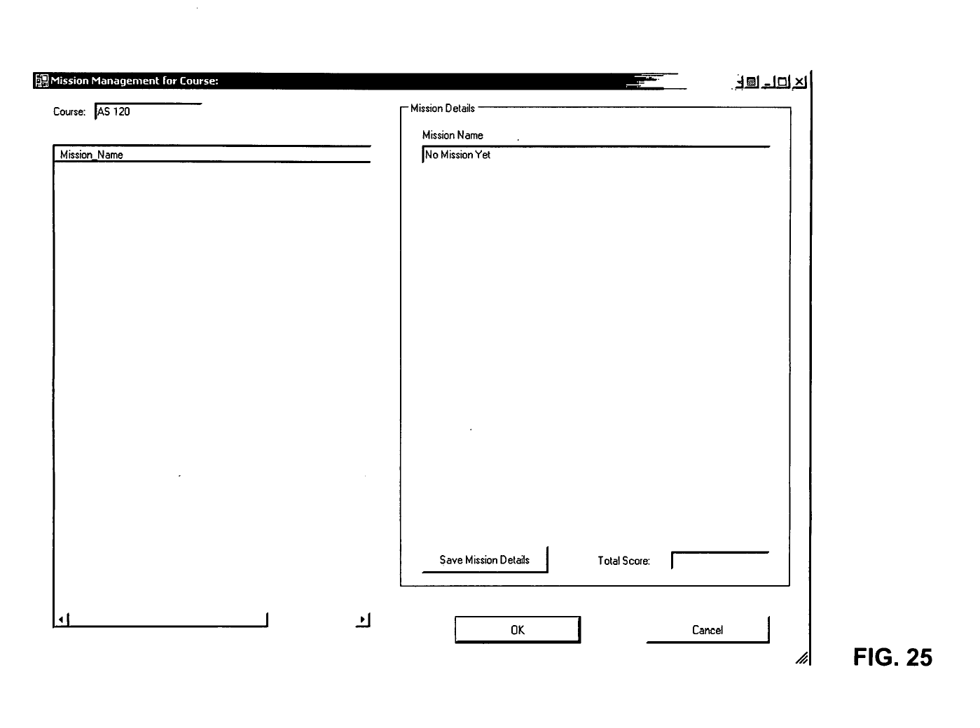

FIG. 25 shows a front view, illustrating a preferred managing screen for managing at least one mission management criterion for at least one aircraft mission by at least one course manager 209 according to the preferred embodiment of the present invention. FIG. 25 shows a basic interface window for course manager 209 to enter the database information required to add or modify at least one mission for at least one course into aircraft electronic flight-mission simulation and scoring system 100, as shown.

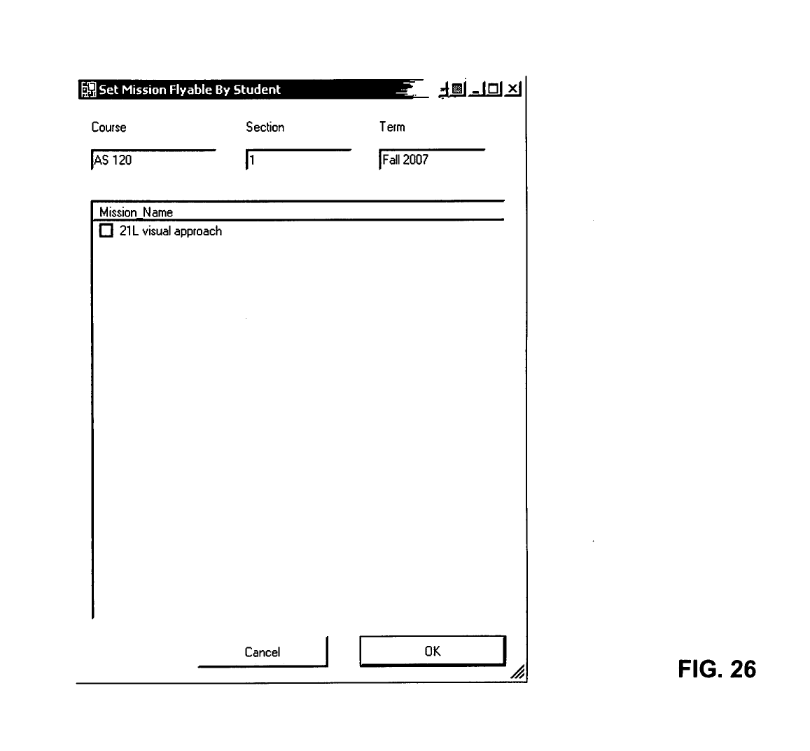

FIG. 26 shows a front view, illustrating a preferred managing screen for managing at least one flyable mission for at least one student 205 by at least one grading instructor 208, according to the preferred embodiment of the present invention. FIG. 26 shows a basic interface window for course manager 209 to enter the database information required to add or modify at least one mission flyable by at least one student 205 into aircraft electronic flight-mission simulation and scoring system 100.

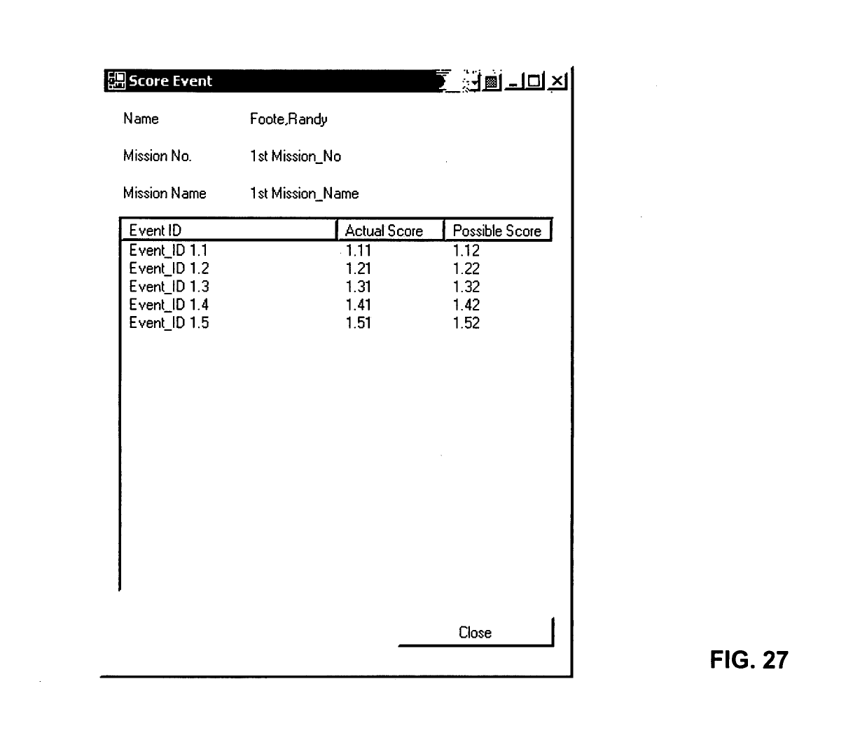

FIG. 27 shows a front view, illustrating a preferred scoring screen for scoring at least one scorable event for at least one student 205 by at least one grading instructor 208, according to the preferred embodiment of the present invention. Scoring is preferably anonymous to avoid flight instructor subjective bias interfering with the scoring of a student flight.

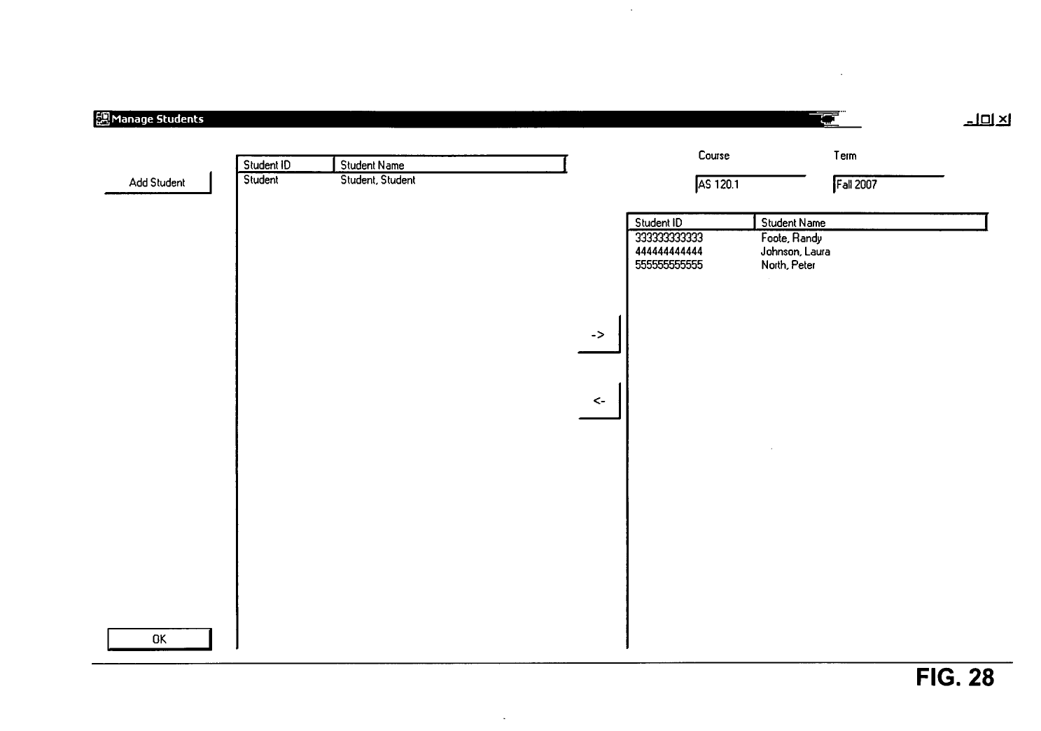

FIG. 28 shows a front view, illustrating a preferred managing screen for managing at least one student management criterion for at least one course for at least one student 205 by at least one course manager 209, according to the preferred embodiment of the present invention. FIG. 28 shows a basic interface window for course manager 209 to enter 100 the database information required to add or modify at least one student 205 to at least one course of at least one term into aircraft electronic flight-mission simulation and scoring system 100.

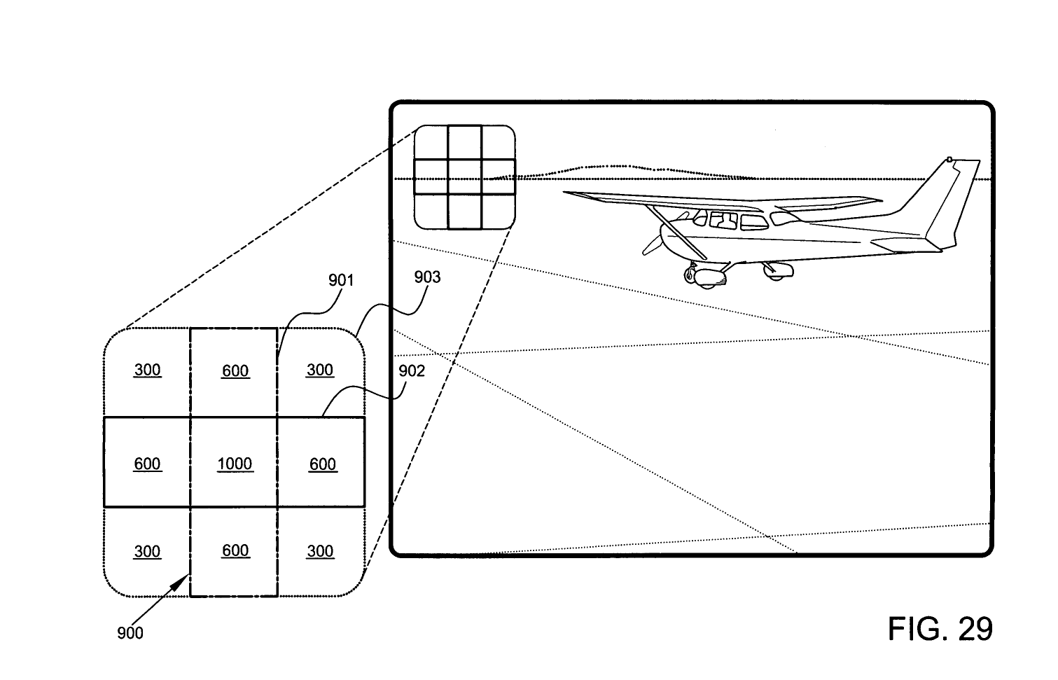

FIG. 29 shows a schematic view, illustrating preferred graduated scoring matrix 900, according to the preferred embodiment of the present invention. Graduated scoring matrix 900 preferably comprises preferably three preferably rectangular scoring geometries: 1) vertical scoring geometry 901; 2) horizontal scoring geometry 902; and 3) composite scoring geometry 903, as shown. The intersection of vertical scoring geometry 901 with horizontal scoring geometry 902 creates a geometrically central gradation of scoring 1000 and off-center axial gradations of scoring 600 that are geometrically related, as shown. Composite scoring geometry 903 substantially encompasses both vertical scoring geometry 901 with horizontal scoring geometry 902, and thus forms the additional off-axis gradations of scoring 300, as shown. Aircraft electronic flight-mission simulation and scoring system 100 utilizes graduated scoring matrix 900 to determine the precision at which user 202 flies aircraft 904 relative to predetermined space coordinates that occur during scorable mission 240. Aircraft electronic flight-mission simulation and scoring system 100 further utilizes graduated scoring matrix 900 to quantify the precision, in space coordinates, at which user 202 maneuvers aircraft 904 within scorable mission 240. Upon reading the teachings of this specification, those with ordinary skill in the art will now understand that, under appropriate circumstances, considering issues such as changes in technology, customer requirements, etc., other geometric scoring matrices, such as, for example, multiple intersecting ovals, multiple adjacent solid-angle shapes based on spherical coordinates yet to be developed, etc., may suffice.

Again referring to FIG. 29, aircraft electronic flight-mission simulation and scoring system 100 utilizes Cartesian space-time (x, y, z, t) coordinates of aircraft 904 relative to pre-determined space coordinates of graduated scoring matrix 900, to determine the precision at which user 202 flies aircraft 904 relative to a plurality of predetermined space-time coordinates that occur during scorable mission 240. Further aircraft electronic flight-mission simulation and scoring system 100 converts the level of precision at which user 202 maneuvers aircraft 904 within one or more scorable mission 240 into a composite standardized score, where the standardized score is based only on the precision that user 202 flies maneuvers aircraft 904 within scorable mission 240. Upon reading the teachings of this specification, those with ordinary skill in the art will now understand that, under appropriate circumstances, considering issues such as changes in technology, customer requirements, etc., other space-time coordinate systems, such as, for example, polar-coordinate based system, steradian-based system yet to be developed, etc., may suffice.

Again referring to FIG. 29, aircraft electronic flight-mission simulation and scoring system 100 converts the level of precision at which each of two or more users 202 maneuver aircraft 904 within one or more scorable mission 240, wherein each user may be provided with at least one composite standardized score. Aircraft electronic flight-mission simulation and scoring system 100 then compares the relative standardized scores of two or more users 202 as a basis for at least one competitive user ranking based upon the standardized score. Thus aircraft electronic flight-mission simulation and scoring system 100 is utilized to competitively relate a plurality of levels of skill of two or more users 202 (at least embodying herein the step of providing at least one competitive user ranking based upon standardized scoring, wherein competition may be related to a plurality of levels of skill). Upon reading the teachings of this specification, those with ordinary skill in the art will now understand that, under appropriate circumstances, considering issues such as changes in technology, competition requirements, etc., other competitive comparison systems, such as, for example, gravitational-force-time based system, fuel-conservation-distance-based system yet to be developed, etc., may suffice.

Upon reading the teachings of this specification, those of ordinary skill in the art will now understand that, under appropriate circumstances, considering such issues as availability of simulation engines and platforms (such as Microsoft® ESP), simulations other than flight missions, such as simulated-complex-operating-machinery, simulated-spaceflight-piloting platform, simulated-sea vehicle-piloting platform, etc.

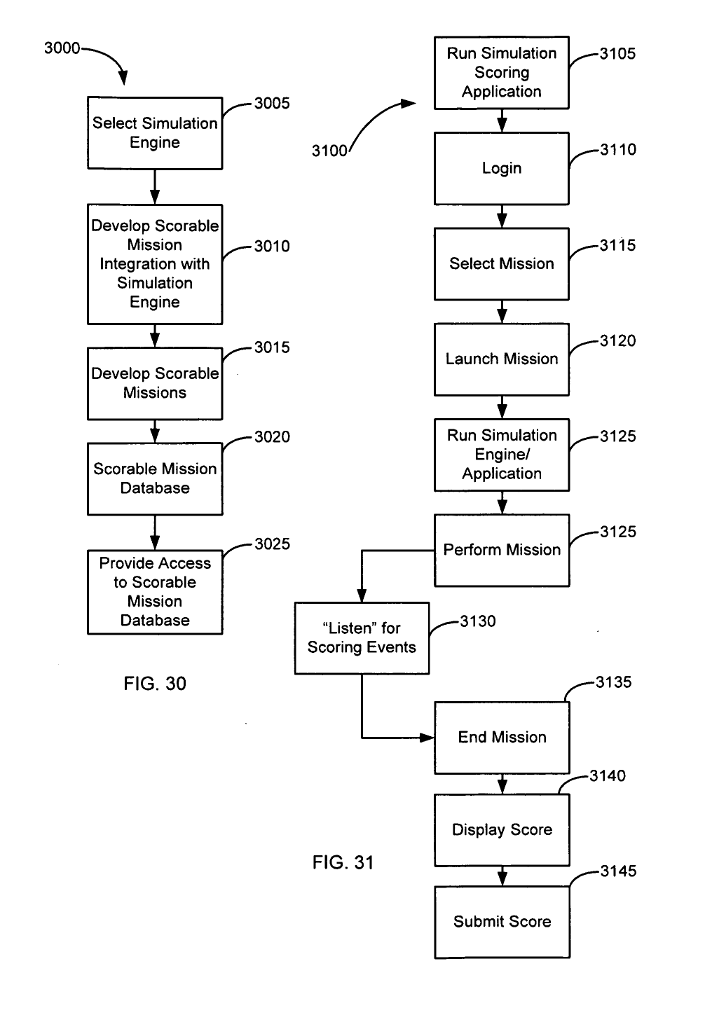

FIG. 30 shows a flowchart illustrating a preferred method, method 3000, of the present invention.

In first preferred step 3005 of method 3000, a simulation engine is selected. As described herein, a preferred simulation engine is Microsoft® Flight Simulator X. To use the simulation engine in a number of environments, one requirement of the selected simulation engine is that it must provide the ability to use custom-developed or -crafted missions; Microsoft® Flight Simulator X provides that ability. The ability to use custom-developed missions is preferably created and handled by a mission engine within the selected simulation engine. Alternatively, missions may also preferably be created and developed with external software (which may be referred to as a “level editor”). Upon reading the teachings of this specification those of ordinary skill in the art will now understand that, under appropriate circumstances, considering issues such as simulation engine features, adoption of a particular simulation engine by users, expandability of a simulation engine, increased need for realism in a simulation, simulation engines developed for a particular industry, simulation engines developed for a particular vehicle, need for dynamic environment variable altering, etc., simulation engines other than Microsoft® Flight Simulator X, such as the Microsoft® ESP simulation engine, may suffice.

In next preferred step 3010 of method 3000, integration of scorable missions with the selected simulation engine is preferably performed. Applicant's research has shown that Microsoft® Flight Simulator X is unable to score a mission. The herein described system provides teachings relating to integrating objective scoring capability with a simulation engine. The scoring capability may be used in many applications, such as aircraft flight testing, space shuttle flight testing, sea-vehicle maneuvering testing, machinery testing. Conventional scoring of performance tests is subjective. Adding an objective testing component is highly preferred. Further, parsing objective requirements from a certification authority, as described above, in a particular field is highly preferred.

In preferred step 3015 of method 3000, scorable missions are developed to be used with a selected simulation engine. Step 3015 may be implemented in many ways. At a preferred minimum, missions must be developed or authored for a particular purpose and the developed missions must be made scorable (have goals and events that may be objectively tested). Depending on the simulation engine selected and the simulation environment (air, space, factory machinery, surgery, etc.), missions that comprise objectively scored goals and events may be integrated with a particular mission. Thus, an airplane flight may be simulated and scored, a space shuttle flight simulated and scored, use of a piece of machinery simulated and scored, use of surgical equipment in an operation may be simulated and scored, etc.

In preferred step 3020 of method 3000, scorable missions are preferably collected and preferably stored in a scorable mission database. In preferred step 3025 of method 3000, access is provided to the scorable mission database. Preferably, a membership-based web site is developed to host scorable missions for download by users of the simulation engine.

FIG. 31 shows a flowchart illustrating a preferred method, method 3100, of the present invention.

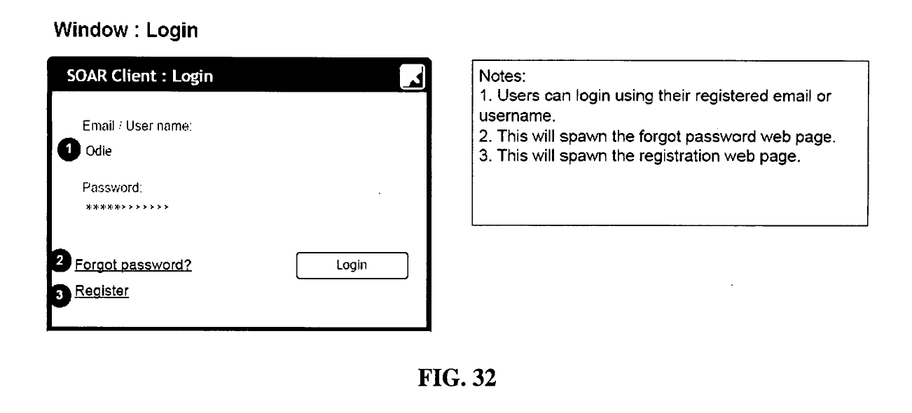

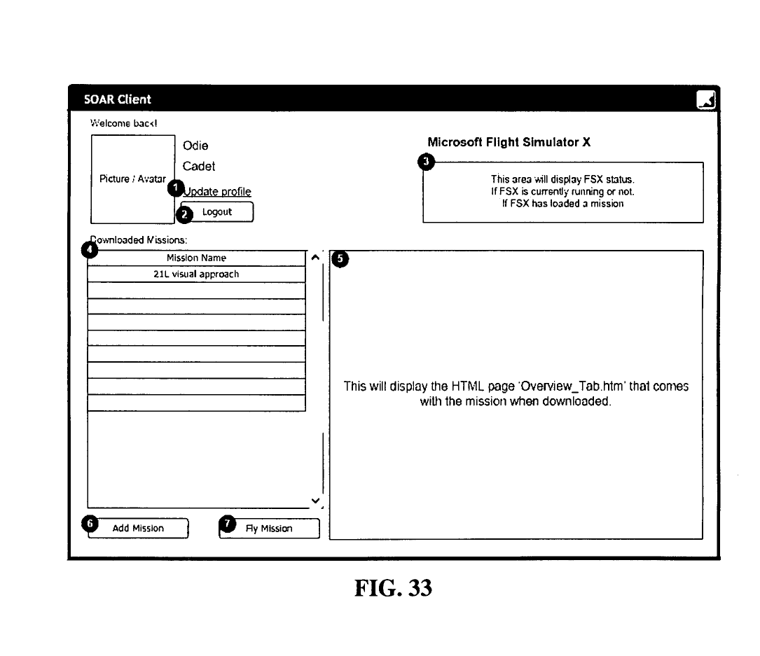

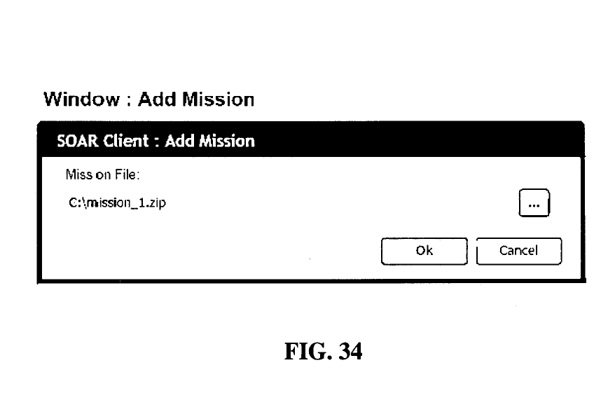

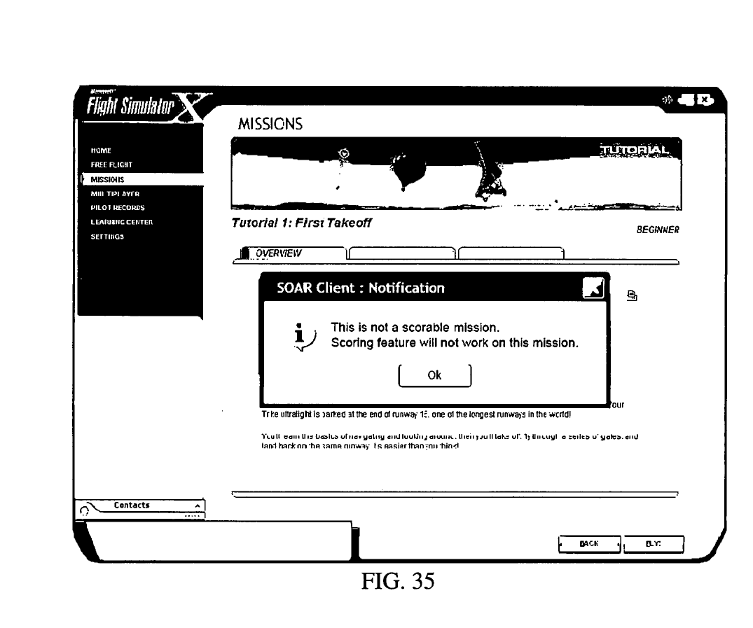

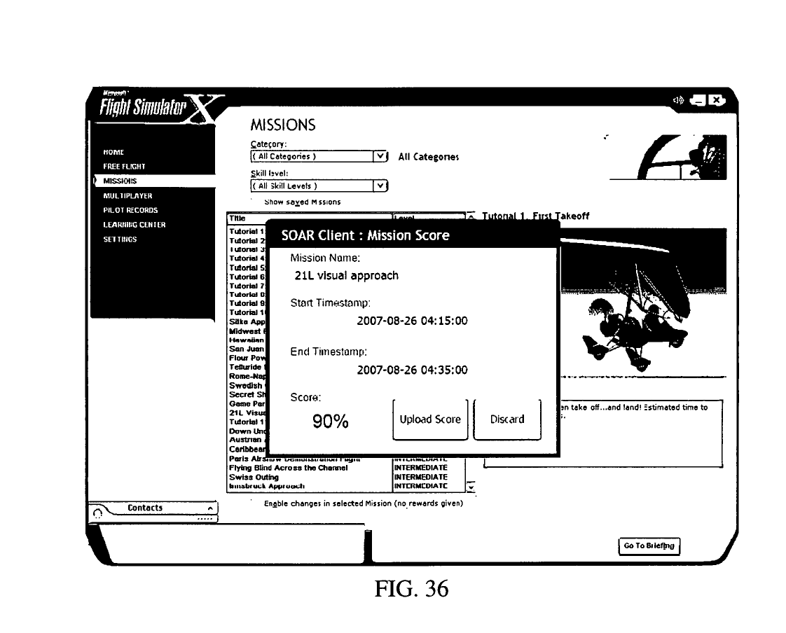

In preferred step 3105 of method 3100, a user runs a simulation scoring system application from a client computer (named the SOAR client in FIG. 32, FIG. 33, FIG. 34, FIG. 35, and FIG. 36). Preferably, a user will login in preferred step 3110 (see FIG. 32) and provide authenticating information. Upon successful authentication, a main window user screen is shown to the user (see FIG. 33). If authentication is unsuccessful, a user may attempt to authenticate again. Upon multiple unsuccessful authentication attempts, the simulation scoring system application will preferably exit.

The main window screen, as shown in FIG. 33, preferably comprises a list of missions that the user may select to launch. Preferably, when a mission is highlighted, a mission brief, or details about the mission, are displayed for the benefit of the user. The mission may be launched (the mission will be loaded by the simulation engine and the user may carry out the mission) by clicking on an appropriate button. Also, preferably, the ability to import a mission downloaded from an external source (such as a Web site) is preferably provided (see FIG. 34). Preferably, downloaded missions are displayed for selection by a user, as shown in FIG. 33. As shown in FIG. 34, a user may preferably update a user profile (after registration) from within the simulation scoring system application. Also, the main window preferably displays the status of the simulation engine (e.g., whether the simulation engine is or is not running). Preferably, an HTML page component displays information about a selected mission. Further, a user may add a mission using the simulation scoring system application (see FIG. 34). When a user is ready to launch a mission to be performed, a mission is selected from a list in preferred step 3115. In preferred step 3120, the mission is launched, preferably by clicking a button that runs the simulation engine/application. The step of running the simulation engine application is preferred step 3125 of method 3100. If a mission is not made “scorable”, the simulation scoring system application preferably delivers an error message to the user stating that the mission is not scorable and the scoring feature will not work on the mission as shown in FIG. 35.

Preferably, the simulation scoring system application will automate the running of the selected simulation engine (preferably Microsoft® Flight Simulator X or a simulation run on, also preferably, on the Microsoft® ESP simulation engine).

After launch of the mission and launch of the simulation engine, a user preferably performs the mission in preferred step 3125, as shown. In preferred step 3125, a user uses a computer input device to control the user-controlled entity in the simulation environment run by the simulation engine. The user will react and perform actions based on events occurring in the simulated environment (e.g., a lightning storm during a flight, a jamming of a piece of machinery, an artery bursting during an operation, etc.). The responses and reactions of the user will be “listened” for and scored. Preferably, the responses and reaction of the user are recorded.

In preferred step 3130 of method 3100, the simulation scoring system application “listens” for mission events for scoring.

The below XML schema illustrates an implementation of the “listening”. In the below XML schema, the goals of the mission are to pass through a series of gates during a landing procedure at a particular real-life simulated runway located in Prescott, Ariz.

```
<?xml version=“1.0” encoding=“Windows-1252”?>
<SimBase.Document Type=“MissionFile” version=“1,0”>
  <Descr>Fly a visual approach into Prescott and land on runway 21L.</Descr>
  <Title>21L Visual Approach</Title>
  <WorldBase.Flight>
    <SimMission.DialogAction InstanceId=“{F4B182BC-E1BD-4DC3-894E-D28238488BE5}”>
      <Descr>DialogAction1</Descr>
      <Text>Gate 1</Text>
      <SoundFileName>ThruHoopC.wav</SoundFileName>
    </SimMission.DialogAction>
    <SimMission.DialogAction InstanceId=“{EE0B45FB-703D-4A71-B4D0-
  D2784BAA2C8D}”>
      <Descr>DialogAction2</Descr>
      <Text>Gate 3</Text>
      <SoundFileName>ThruHoopC.wav</SoundFileName>
    </SimMission.DialogAction>
    <SimMission.DialogAction InstanceId=“{6844915A-D3BC-4664-B568-689735450AF8}”>
      <Descr>DialogAction3</Descr>
      <Text>Nice landing!! You should be a pilot!</Text>
    </SimMission.DialogAction>
    <SimMission.DialogAction InstanceId=“{093249A9-D252-4306-9E71-997631A21BC2}”>
      <Descr>DialogAction4</Descr>
      <Text>Gate 2</Text>
      <SoundFileName>ThruHoopC.wav</SoundFileName>
    </SimMission.DialogAction>
    <SimMission.GoalResolutionAction InstanceId=“{EAC8B91C-3A42-4940-83C1-
  77E197B2B73E}”>
      <Descr>GoalResolutionAction9</Descr>
      <Goals>
        <ObjectReference id=“Goal1” InstanceId=“{7AD52BA5-20BE-4441-9DDF-
  EE8DDEE6796A}”>
        </ObjectReference>
      </Goals>
    </SimMission.GoalResolutionAction>
    <SimMission.CustomAction InstanceId=“{150E2FC6-E8AB-456A-84B6-31807B1A7492}”>
      <Descr>ScorableEvent_Airport_Landing_Trigger</Descr>
      <PayloadString>4</PayloadString>
    </SimMission.CustomAction>
    <SimMission.CustomAction InstanceId=“{050D353A-9CED-4B6F-9A6D-
  193DE9C9C76A}”>
      <Descr>ScorableEvent_Gate_1</Descr>
      <PayloadString>1</PayloadString>
    </SimMission.CustomAction>
    <SimMission.CustomAction InstanceId=“{FD31BB37-F3F2-4705-9FE0-
  D38EEBEFB59C}”>
      <Descr>ScorableEvent_Gate_2</Descr>
      <PayloadString>2</PayloadString>
    </SimMission.CustomAction>
    <SimMission.CustomAction InstanceId=“{00C00A83-345D-49C8-9E6A-
  54EA98BA1E91}”>
      <Descr>ScorableEvent_Gate_3</Descr>
      <PayloadString>3</PayloadString>
    </SimMission.CustomAction>
    <SimMission.RectangleArea InstanceId=“{CC5B07CF-F7F0-4548-BEA2-
  32C49A41B6A6}”>
      <Descr>RectangleArea1</Descr>
      <Orientation>0.000,0.000,310.500</Orientation>
      <Width>100.000</Width>
      <Height>100.000</Height>
      <Length>25.000</Length>
      <AttachedWorldPosition>
        <WorldPosition>N34° 41′ 39.97″,W112° 22′ 37.29″,+005900.00</WorldPosition>
        <AltitudeIsAGL>False</AltitudeIsAGL>
      </AttachedWorldPosition>
    </SimMission.RectangleArea>
    <SimMission.RectangleArea InstanceId=“{F2D19B96-2691-4C54-9A51-
  4BAB2EEC8944}”>
      <Descr>RectangleArea2</Descr>
      <Orientation>0.000,0.000,42.300</Orientation>
      <Width>25.000</Width>
      <Height>100.000</Height>
      <Length>100.000</Length>
      <AttachedWorldPosition>
        <WorldPosition>N34° 39′ 46.76″,W112° 24′ 37.80″,+000000.00</WorldPosition>
        <AltitudeIsAGL>True</AltitudeIsAGL>
      </AttachedWorldPosition>
    </SimMission.RectangleArea>
    <SimMission.RectangleArea InstanceId=“{3DA8D31F-3A83-449B-B4D8-
  8C4365CCC838}”>
      <Descr>RectangleArea3</Descr>
      <Orientation>0.000,0.000,45.000</Orientation>
      <Length>100.000</Length>
      <Width>25.000</Width>
      <Height>100.000</Height>
      <AttachedWorldPosition>
        <WorldPosition>N34° 40′ 43.18″,W112° 24′ 12.21″,+000000.00</WorldPosition>
        <AltitudeIsAGL>True</AltitudeIsAGL>
      </AttachedWorldPosition>
    </SimMission.RectangleArea>
    <SimMission.AirportLandingTrigger InstanceId=“{B28B9D8E-E95F-4899-8144-
  432766C06407}”>
      <Descr>AirportLandingTrigger3</Descr>
      <AirportIdent>KPRC</AirportIdent>
      <LandingType>TouchDown</LandingType>
      <Actions>
        <ObjectReference id=“DialogAction3” InstanceId=“{6844915A-D3BC-4664-B568-
  689735450AF8}”>
        </ObjectReference>
        <ObjectReference id=“ScorableEvent_Airport_Landing_Trigger”
  InstanceId=“{150E2FC6-E8AB-456A-84B6-31807B1A7492}”>
        </ObjectReference>
        <ObjectReference id=“GoalResolutionAction9” InstanceId=“{EAC8B91C-3A42-4940-
  83C1-77E197B2B73E}”>
        </ObjectReference>
      </Actions>
      <RunwayFilter>
        <RunwayNumber>21</RunwayNumber>
        <RunwayDesignator>Left</RunwayDesignator>
      </RunwayFilter>
    </SimMission.AirportLandingTrigger>
    <SimMission.ProximityTrigger InstanceId=“{22BBFEAA-CD89-4F41-943F-
  08CB41B8AA74}”>
      <Descr>ProximityTrigger1</Descr>
      <OnEnterActions>
        <ObjectReference id=“DialogAction1” InstanceId=“{F4B182BC-E1BD-4DC3-894E-
  D28238488BE5}”>
        </ObjectReference>
        <ObjectReference id=“ScorableEvent_Gate_1” InstanceId=“{050D353A-9CED-4B6F-
  9A6D-193DE9C9C76A}”>
        </ObjectReference>
      </OnEnterActions>
      <Areas>
        <ObjectReference id=“RectangleArea1” InstanceId=“{CC5B07CF-F7F0-4548-BEA2-
  32C49A41B6A6}”>
        </ObjectReference>
      </Areas>
    </SimMission.ProximityTrigger>
    <SimMission.ProximityTrigger InstanceId=“{9E5886DE-3BBD-4297-A64A-
  05E811BDA0071}”>
      <Descr>ProximityTrigger2</Descr>
      <OnEnterActions>
        <ObjectReference id=“DialogAction2” InstanceId=“{EE0B45FB-703D-4A71-B4D0-
  D2784BAA2C8D}”>
        </ObjectReference>
        <ObjectReference id=“ScorableEvent_Gate_3” InstanceId=“{00C00A83-345D-49C8-
  9E6A-54EA98BA1E91}”>
        </ObjectReference>
      </OnEnterActions>
      <Areas>
        <ObjectReference id=“RectangleArea2” InstanceId=“{F2D19B96-2691-4C54-9A51-
  4BAB2EEC8944}”>
        </ObjectReference>
      </Areas>
    </SimMission.ProximityTrigger>
    <SimMission.ProximityTrigger InstanceId=“{E2B12F0E-9FFB-49DD-B3FE-
  901EE82DA761}”>
      <Descr>ProximityTrigger4</Descr>
      <OnExitActions>
        <ObjectReference id=“ScorableEvent_Gate_2” InstanceId=“{FD31BB37-F3F2-4705-
  9FE0-D38EEBEFB59C}”>
        </ObjectReference>
      </OnExitActions>
      <OnEnterActions>
        <ObjectReference id=“DialogAction4” InstanceId=“{093249A9-D252-4306-9E71-
  997631A21BC2}”>
        </ObjectReference>
      </OnEnterActions>
      <Areas>
        <ObjectReference id=“RectangleArea3” InstanceId=“{3DA8D31F-3A83-449B-B4D8-
  8C4365CCC838}”>
        </ObjectReference>
      </Areas>
    </SimMission.ProximityTrigger>
    <SceneryObjects.LibraryObject InstanceId=“{2A32C73D-786D-42CE-95AB-
  7E012394069B}”>
      <Descr>GEN_game_1_blue</Descr>
      <MDLGuid>{6079F842-015B-4017-A391-7C0F23BCBCD1}</MDLGuid>
      <WorldPosition>N34° 41′ 39.97″,W112° 22′ 37.29″,+001042.65</WorldPosition>
      <Orientation>0.000,0.000,39.600</Orientation>
      <AltitudeIsAGL>True</AltitudeIsAGL>
      <Scale>1.000</Scale>
    </SceneryObjects.LibraryObject>
    <SceneryObjects.LibraryObject InstanceId=“{98376A65-2303-42D0-8B7C-
  3F7E8C7392A5}”>
      <Descr>GEN_game_2_blue</Descr>
      <MDLGuid>{3D49D581-9163-4A7A-B957-3CB7B7D4BAF4}</MDLGuid>
      <WorldPosition>N34° 40′ 43.18″,W112° 24′ 12.21″,+000100.00</WorldPosition>
      <Orientation>0.000,0.000,45.000</Orientation>
      <AltitudeIsAGL>True</AltitudeIsAGL>
      <Scale>1.000</Scale>
    </SceneryObjects.LibraryObject>
    <SceneryObjects.LibraryObject InstanceId=“{14F506BD-925E-4785-A14F-
  05741381733E}”>
      <Descr>GEN_game_3_blue</Descr>
      <MDLGuid>{7826E942-B632-4A73-8822-C25242334730}</MDLGuid>
      <WorldPosition>N34° 39′ 46.76″,W112° 24′ 37.80″,+000098.43</WorldPosition>
      <Orientation>0.000,0.000,45.000</Orientation>
      <AltitudeIsAGL>True</AltitudeIsAGL>
      <Scale>1.000</Scale>
    </SceneryObjects.LibraryObject>
    <SceneryObjects.LibraryObject InstanceId=“{F10F574D-FCE7-46FF-B173-
  5D4504981433}”>
      <Descr>gen_game_hoop_ACTIVE</Descr>
      <MDLGuid>{00985A24-4AF0-4F5E-BA64-32F165A7FE55}</MDLGuid>
      <WorldPosition>N34° 41′ 39.97″,W112° 22′ 37.29”,+005900.00</WorldPosition>
      <Orientation>0.000,0.000,39.600</Orientation>
      <AltitudeIsAGL>False</AltitudeIsAGL>
      <Scale>1.000</Scale>
    </SceneryObjects.LibraryObject>
    <SceneryObjects.LibraryObject InstanceId=“{B13B73CE-E136-4A2E-9C70-
  278D4B27F7BC}”>
      <Descr>gen_game_hoop_ACTIVE</Descr>
      <MDLGuid>{00985A24-4AF0-4F5E-BA64-32F165A7FE55}</MDLGuid>
      <WorldPosition>N34° 40′ 43.18″,W112° 24′ 12.21″,+000000.00</WorldPosition>
      <Orientation>0.000,0.000,45.000</Orientation>
      <AltitudeIsAGL>True</AltitudeIsAGL>
      <Scale>1.000</Scale>
    </SceneryObjects.LibraryObject>
    <SceneryObjects.LibraryObject InstanceId=“{59EE225B-878F-4E69-B739-
  F502C01165EC}”>
      <Descr>gen_game_hoop_ACTIVE</Descr>
      <MDLGuid>{00985A24-4AF0-4F5E-BA64-32F165A7FE55}</MDLGuid>
      <WorldPosition>N34° 39′ 46.76″,W112° 24′ 37.80″,+000000.00</WorldPosition>
      <Orientation>0.000,0.000,45.000</Orientation>
      <AltitudeIsAGL>True</AltitudeIsAGL>
      <Scale>1.000</Scale>
    </SceneryObjects.LibraryObject>
    <SimMissionUI.ScenarioMetadata InstanceId=“{1190BBE7-F418-46AC-9228-
  03F8A3C3EDCD}”>
      <Descr>ScenarioMetadata1</Descr>
      <ScenarioType>Mission</ScenarioType>
      <EstimatedTime>10</EstimatedTime>
      <UncompletedImage>C-172_I.bmp</UncompletedImage>
      <CompletedImage>C-172_C.bmp</CompletedImage>
      <MissionBrief>Overview_Tab.htm</MissionBrief>
      <CategoryRef>{1CCE1FA0-D1C6-409B-A169-91DB5F5B6EFB}</CategoryRef>
    </SimMissionUI.ScenarioMetadata>
    <SimMission.Goal InstanceId=“{7AD52BA5-20BE-4441-9DDF-EE8DDEE6796A}”>
      <Descr>Goal1</Descr>
      <Text>Landing on runway 21L</Text>
      <Order>1</Order>
    </SimMission.Goal>
  </WorldBase.Flight>
  <MissionBuilder.MissionBuilder>
  </MissionBuilder.MissionBuilder>
</SimBase.Document>
```

At the end of the mission, preferred step 3135, the simulation scoring system application displays the score to the user. The score display occurs in preferred step 3140 of method 3100, as shown. A screenshot of a score display is shown in FIG. 36. The score display screen preferably displays the mission name, the start and end times of the mission, and the mission score (preferably expressed as a percentage), as shown in FIG. 36.

In preferred step 3145 of method 3100, a user may desire to submit the score to a database that will store scores from scorable missions. The score-storing database is preferably accessible via the Internet. To submit scores, an “upload score” button is provided. The “upload score” button is preferably provided on or within a score display screen, as shown in FIG. 36. Upon clicking the “upload score” button (with the aid of a computer input device), the score and related data are preferably uploaded to be remotely stored. Alternately preferably, the score may be automatically submitted for storage without user input. Remote storage of uploaded scores is preferably in a web-accessible database.

Preferably, a web site of users of the simulation engine is established. Preferably, users may upload scores to such a web site and engage in competition with one another. Also, preferably missions may be developed and stored. The stored missions may be downloaded by authorized members of the web site and used with the simulation engine. Also preferably, missions created by third parties may be submitted for storage on the web site to be downloaded and used with the simulation engine. Scores of completed missions are preferably submitted for storage on the web site. Data analysis and reports of submitted scores may be performed (e.g., rankings, last 10 submitted scores, historical score reporting, scores linked with a particular registered member, etc.).

The herein disclosed systems enable implementing scorable simulation training environments as well as implementing scorable simulation gaming competition communities. Also, the herein disclosed systems provide scoring of simulations with highly realistic simulation environments at a reasonable cost for both training purposes and for entertainment purposes.

Although applicant has described applicant's preferred embodiments of this invention, it will be understood that the broadest scope of this invention includes. Such scope is limited only by the below claims as read in connection with the above specification. Further, many other advantages of applicant's invention will be apparent to those skilled in the art from the above descriptions and the below claims.

What is claimed is:

1) A simulation scoring computing system comprising:
a) at least one scorable mission computing system to run at least one scorable mission with at least one simulation engine;
b) at least one score calculator computing system to calculate the score of such at least one scorable mission when performed by at least one mission performer;
c) at least one calculated score requester computing system to request at least one calculated score of such at least one scorable mission performed by at least one mission performer;
d) at least one calculated score reporter computing system to report at least one calculated score of such at least one scorable mission performed by at least one mission performer;
e) at least one calculated score storer computing system to store the requested at least one calculated score of such at least one scorable mission performed by at least one mission performer; and
f) at least one management application computing system useable to manage at least such at least one scorable mission and such at least one calculated score.

2) The simulation scoring computing system according to claim 1, wherein said at least one management application computing system comprises at least one scorable mission assignment assister computing system to assist assignment of such at least one scorable mission to at least one mission performer.

3) The simulation scoring computing system according to claim 1, wherein said at least one management application computing system comprises at least one scoring criteria manager computing system to manage the scoring criteria of such at least one scorable mission.

4) The simulation scoring computing system according to claim 1, wherein said at least one management application computing system comprises at least one calculated score viewer computing system to view such at least one calculated score of such at least one scorable mission.

5) The simulation scoring computing system according to claim 1, wherein said at least one management application computing system comprises at least one course associater computing system to associate such at least one scorable mission with at least one curricular course.

6) The simulation scoring computing system according to claim 5, wherein said at least one management application computing system comprises at least one section associater computing system to associate such at least one curricular course with at least one section.

7) The simulation scoring computing system according to claim 5, wherein said at least one management application computing system comprises at least one academic term associater computing system to associate such at least one curricular course with at least one academic term.

8) The simulation scoring computing system according to claim 1, wherein said at least one management application computing system comprises at least one mission-performer access manager computing system to manage mission-performer access to such at least one scorable mission.

9) The simulation scoring computing system according to claim 1, further comprising at least one network accessible storage of such at least one scorable mission.

10) The simulation scoring computing system according to claim 1, further comprising at least one mission-performer calculated score associater computing system to associate such at least one calculated score with at least one mission performer.

11) The simulation scoring computing system according to claim 5, wherein said at least one management application computing system comprises at least one mission performer associater computing system to associate at least one mission performer with at least one curricular course.

12) The simulation scoring computing system according to claim 5, wherein said at least one management application computing system comprises at least one curricular instructor associater computing system to associate at least one curricular instructor with at least one curricular course.

13) A method of a simulation scoring system, said method comprising the steps of:
a) selecting at least one simulation engine;
b) developing at least one scorable mission integration system with the at least one simulation engine;
c) developing at least one scorable mission;
d) storing said at least one scorable mission in at least one scorable mission database;
e) providing access to the at least one scorable mission database.

14) The method according to claim 13, further comprising the step of providing receiving at least one score related to at least one scorable mission that has been completed.

15) The method according to claim 13, further comprising the steps of providing at least one scorable mission manager application to assist managing data related to at least one scorable mission that has been completed.

16) The method according to claim 15, wherein the at least one scorable mission manager application comprises:
a) at least one scorable mission selection assister to assist selection of at least one scorable mission;
b) at least one scorable mission launcher to launch at least one scorable mission;
c) at least one simulation engine launcher, responsive to said at least one scorable mission launcher, to launch at least one simulation engine;
d) at least one score analyzer to analyze at least one scorable occurrence during performance of such at least one launched scorable mission; and
e) at least one score recorder to record at least one analyzed score.

17) A scorable mission manager application of a simulation scoring system comprising:
a) at least one scorable mission selection assister to assist selection of at least one scorable mission;
b) at least one scorable mission launcher to launch at least one scorable mission;
c) at least one simulation engine launcher, responsive to said at least one scorable mission launcher, to launch at least one simulation engine;
d) at least one score analyzer to analyze at least one scorable occurrence during performance of such at least one launched scorable mission; and
e) at least one score recorder to record at least one analyzed score.

18) The scorable mission manager application of claim 17, further comprising at least one score displayer to display such at least one analyzed score upon completion of said at least one launched scorable mission.

19) The scorable mission manager application according to claim 12, further comprising at least one score submission assister to assist submission of at least one score to at least one score storage database.

20) A simulation scoring system comprising:
a) at least one piloting simulator to simulate aircraft piloting on at least one computer;
b) at least one flyable mission to simulate at least one flight mission flyable by at least one user using said at least one piloting simulator; and
c) at least one scorable-event contained within said at least one flyable mission;
d) wherein said at least one scorable event comprises at least one customizable score attribute.

21) The simulation scoring system according to claim 20, further comprising at least one score computer to compute at least one summary score.

22) The system according to claim 21, further comprising at least one score displayer to display such at least one summary score.

23) A computational system comprising:
a) at least one piloting simulation computer processor adapted to simulate aircraft piloting on at least one computational platform;
b) at least one flyable mission computer processor adapted to simulate at least one flight mission flyable by at least one user using said flyable mission computer processor;
c) at least one scorable-events computer processor adapted to generate multiple quantitative scoring levels of each of a plurality of scorable events along such at least one simulated flight mission to provide at least one scorable mission; and
d) at least one scorer computer processor adapted to provide at least one summary score, relating to said at least one scorable mission, relating to such generated multiple quantitative scoring levels of each such one of such plurality of scorable events.

24) The computational system according to claim 23, further comprising at least one score viewer to permit viewing such multiple quantitative scoring levels.

25) The computational system according to claim 24, further comprising at least one parsing system to parse at least one certification requirement of at least one real-life certifying organization and to provide use the parsed at least one certification requirement as at least one scorable event.

26) The computational system according to claim 25, further comprising at least one simulator for simulating at least one certification requirement of at least one real-flight certification of at least one real-life certifying organization.

27) The computational system according to claim 23, further comprising at least one score ranker to provide at least one ranking of scores.

28) The computational system according to claim 26, further comprising at least one score ranker to provide at least one ranking of scores.

29) A method comprising the steps of:
a) providing at least one simulation platform;
b) providing at least one simulated mission operable by at least one user using such at least one simulation platform;
c) providing quantitative scoring of a plurality of scorable events along such at least one simulated mission by generating multiple quantitative scoring levels of each of such plurality of scorable events along such at least one simulated mission to provide at least one scorable mission; and
d) providing at least one network to operate such at least one simulated platform; and
e) wherein such at least one user may connect with such at least one network to operate such at least one simulated mission.

30) The method according to claim 29, wherein said at least one simulated mission is at least one simulated spaceflight mission.

31) The method according to claim 29, wherein said at least one simulated mission is at least one simulated sea-going mission.

32) The method according to claim 29, wherein said at least one simulated mission is at least one simulated complex-operating-machinery mission.
